(19) United States
(12) Patent Application Publication
(10) Pub. No.: US 2026/0355759 A1
(43) Pub. Date: Nov. 12, 2026

(54) APPENDAGE WASHING APPARATUS

(71) Applicant: Meritech Systems, LLC, Golden, CO (US)

(72) Inventor: Joshua V. Morsicato, Arvada, CO (US)

(21) Appl. No.: 19/671,039

(22) Filed: May 7, 2026

Related U.S. Application Data
(60) Provisional application No. 63/801,334, filed on May 7, 2025.

(51) Int. Cl. B05B 1/34; B08B 3/02

(52) U.S. Cl. CPC B05B 1/34; B08B 3/02; B08B 2203/02

(57) ABSTRACT

An improved appendage washing apparatus to clean an object or a body part of a person includes nozzles on an interior of a cylinder, the nozzles generating a novel spray pattern. In addition, embodiments of the disclosure include fluid guidance and conveyance structures, angled nozzles, sealing structures, finger guards, nozzle ribs, wash chamber seating mechanisms and drains, and nozzle inlays having a plurality of nozzles. Also disclosed are methods of washing an object or body part using an apparatus or chamber and methods of assembling an apparatus or chamber. The nozzles of the improved appendage washing apparatus require a reduced amount of water to generate a more desirable flow for cleaning the object or the body part of the person.

### CROSS REFERENCE TO RELATED APPLICATIONS

This U.S. Non-Provisional Patent Application claims the benefit of priority under 35 U.S.C. § 119(e) of U.S. Provisional Patent Application Ser. No. 63/801,334 filed May 7, 2025, the entire disclosure of which is hereby incorporated by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### FIELD

The present disclosure relates to wash chambers for use in automated cleaning systems, and more particularly, to wash chambers used in automated washing devices used to clean at least a portion of an object or an appendage of a user.

### BACKGROUND

The background description includes information that may be useful in understanding the present inventive subject matter. It is not an admission that any of the information provided herein is prior art or relevant to the presently claimed disclosure, or that any publication specifically or implicitly referenced is prior art.

Touchless automated hand-washing devices that incorporate rotating cylinders are known and have been in use for some time. These devices are designed to wash and/or provide a proper amount of anti-microbial solution to a person's hand and forearm within a set time. The cylinders can be mounted in a free-standing device and are adapted to receive the person's hand and forearm. The cylinders include an annulus or inner cavity that, in operation, is filled with cleaning fluid. As the inner cavity is filled, the cleaning fluid is forced out of a nozzle arrangement on the inner surface of the cylinder and into the interior of the cylinder. In order to provide greater coverage of the hand and forearm, the cylinders are rotated to provide a spray pattern.

A nozzle arrangement known in the prior art is disclosed by U.S. Pat. No. 4,817,651 (“the '651 patent”). This patent discloses a three-set grouping of nozzles positioned on the interior surface of the rotating cylinder. A first set of nozzles is positioned on a closed end of the cylinder opposite from an open end through which a person's hands are placed. The closed end includes a frusto-conical shape that allows the first set of nozzles to be positioned such that cleaning fluid is sprayed toward the user's hand. Additionally, the frusto-conical end portion may include a drain through which spent cleaning fluid may exit the cylinder. A second set of nozzles are arranged in a ring on the inner surface of the cylinder just inside the open end. The second set of nozzles are angled downward, such that their spray is directed into the cylinder. A third set of nozzles are positioned in a helical array along the length of the cylinder.

As described in the '651 patent, the fingernails and the ends of the fingers receive a direct spray from the first set of nozzles. Secondly, the spray pattern that results from the second set of nozzles produces a “curtain” that prevents the cleaning fluid from being splashed or sprayed out of the cylinder. Lastly, the helical arrangement of nozzles along the length of the cylinder in combination the rotation of the cylinders results in debris and spent cleaning fluid being swept downward, toward the closed end of the cylinder. In particular, the third set of nozzles are disposed in a left-hand helical pattern which, when combined with the clock-wise rotation of the cylinders, results in a succession of sprays that travel down the arm from above the wrist towards the fingertips.

The spray pattern that results from the nozzle arrangement depends in part on the orientation and spray pattern of the individual nozzles. While the '651 patent contains little discussion of these details, U.S. Pat. No. 5,823,447 (“the '447 patent”) is directed to an angled fan nozzle for use with a rotating cleaning cylinder. The nozzle construction disclosed in the '447 patent produces a flat “fan” pattern. In particular, cleaning fluid is ejected into the interior of the cylinder from a nozzle having a small square aperture. The spray of cleaning fluid spreads out through an angle while remaining substantially in a single plane. The nozzle is constructed such that the plane of the fan spray pattern is angled at 15 degrees with respect to the axis of the nozzle. As described in the '447 patent, the nozzle may be positioned on the interior of the cylinder at a 15-degree tilt towards the closed end of the cylinder. The 15-degree angle of the fan spray combines with the 15-degree tilt of the nozzle, resulting in a fan spray directed partially downwards, towards the closed end of the cylinder. With respect to the plane of the cylinder opening, the fan spray is directed downward at a 30-degree angle. This downwardly angled fan spray operates to direct spent cleaning fluid downwards, towards the closed end of the cylinder.

While the '447 patent discloses an angle of the flat fan spray with respect to the plane of the cylinder opening, this reference is silent as to the rotational orientation of the fan spray pattern around with respect to the normal of the inner wall (or “roll” angle as defined later herein). For example, a particular nozzle may be positioned in a 0-degree rotational orientation, such that the flat fan spray is ejected from the nozzle “horizontally,” that is, in a plane parallel with the plane of the cylinder opening. Alternatively, a particular nozzle may be positioned in the 90-degree orientation such that the flat fan spray is ejected “vertically,” that is, in a plane perpendicular to the plane of the cylinder opening. As can be appreciated, a particular nozzle can be positioned at any angle between 0 and 90 degrees such that the flat fan spray has both a vertical and horizontal component.

It has been found that particular orientations and arrangements of nozzles not disclosed or suggested by the '651 patent or the '447 patent, such as the rotational orientation of particular nozzles, produce a novel spray pattern having increased coverage of the hand and forearm of the user (or other object to be cleaned). Additionally, the prior art fails to disclose other novel features associated with the cylinders that allow for faster and more reliable completion of wash cycles, safer operation, and easier assembly. Further, the prior art fails to disclose other novel features associated with the cylinders that allow for reduced water usage, reduced downtime between cleanings, and a more desirable or beneficial spray pattern having increased coverage of the hand and forearm of the user (or other object to be cleaned).

### SUMMARY

Accordingly, there exists a long-felt but unmet need to improve upon the above-discussed failures or shortcomings of the known washing apparatuses. In particular, improvements of the present disclosure are directed to a novel spray pattern having increased coverage of the hand and forearm of the user (or other object to be cleaned). In addition, improvements described in the present disclosure are directed to other novel features associated with the cylinders that allow for faster and more reliable completion of wash cycles, safer operation, and easier assembly. Further, improvements described in the present disclosure are directed to other novel features associated with the cylinders that allow for reduced water usage, reduced downtime between cleanings, and a more desirable or beneficial spray pattern having increased coverage of the hand and forearm of the user (or other object to be cleaned).

Embodiments of the present disclosure are directed to a chamber, such as a wash chamber or cylinder, for use in connection with an automated fluid dispensing apparatus, such as a hand-washing machine. An embodiment of the apparatus described herein includes a plurality of nozzles disposed on the interior of the cylinder that deliver water and/or cleaning fluid as the cylinder rotates around a person's hand and forearm. The cylinder includes an inner cylinder coupled to an outer cylinder. Water and/or cleaning fluid is delivered to the nozzles through an inner cavity located between the inner and outer cylinders.

Wash cylinders in accordance with embodiments of the present disclosure include features that allow for fast, reliable delivery of water and/or cleaning fluid. At least one embodiment of the present disclosure comprises a cylinder that includes a flow guidance structure disposed on a surface of the inner cylinder that reduces turbulence of the incoming fluid flow. Additionally, the cylinder may include a sealing mechanism that results in greater reliability under high pressure conditions.

Cylinders in accordance with embodiments of the present disclosure include drain holes sized to prevent fingers and/or jewelry from being caught while the cylinder is in motion. In particular, the drain holes or perforations may be between approximately 1/32 inch and approximately ¼-inch in diameter. Additionally, embodiments of the cylinder include structure that prevents fingers and/or jewelry from being caught between the rotating cylinder and non-moving parts of the machine.

Cylinders in accordance with embodiments of the present disclosure include features that produce an advantageous spray pattern. At least one embodiment of the present disclosure uses a multi-set nozzle arrangement having one or more sets of different nozzle types. In contrast to the prior art, the present disclosure includes a novel arrangement of nozzles that produce improved coverage of the hand and forearm of the user.

Embodiments of the present disclosure may comprise a nozzle strip or inlay that includes a plurality of nozzles along a preferred alignment, such as a linear alignment, a helical alignment, and/or a curved alignment. Embodiments of the present disclosure may comprise a fluid conveyance feature to limit fluid volumes and decrease the cycle time. Embodiments of the present disclosure may comprise the determination of location and/or position (e.g., angle and/or orientation) of nozzles within the apparatus (e.g., within the inner cylinder of the apparatus) to produce a pre-determined spray pattern to clean an object, having a desired flow rate through the apparatus and/or nozzle impact at select locations within the cavity housing the object to the cleaned.

To further support the written description requirement, examples of washing systems may be found in U.S. Pat. No. 7,607,442, issued Oct. 27, 2009, which is incorporated herein in its entirety.

Embodiments of the present disclosure may comprise any one or more of the novel features described herein, including the in the Detailed Description, and/or shown in the drawings.

A first aspect of the present disclosure is to provide an apparatus for a cleaning system. The apparatus includes an outer cylinder with a water inlet and at least one opening. The apparatus includes an inner cylinder with a plurality of apertures and at least one drain in fluid communication with a defined internal cavity, where the at least one drain exits through the at least one opening of the outer cylinder. The apparatus includes a plurality of nozzles. Each nozzle of the plurality of nozzles is located within a particular aperture of the plurality of apertures. Each nozzle of the plurality of nozzles includes an entry aperture within an entry end of the nozzle, an exit aperture within an exit end of the nozzle, and a basin in fluid communication with the entry aperture and the exit aperture, where a first portion of the basin at the exit aperture is an approximately an ellipsoid with an elliptical cross-section.

The apparatus of the first aspect may include, optionally, that a second portion of the basin at the entry aperture is approximately a frustum with a frusto-conical cross-section, and that the frustum transitions into the ellipsoid between the entry aperture and the exit aperture.

The apparatus of the first aspect may include one or more of the previous embodiments and, optionally, that the exit aperture is formed via a wedge cut within the exit end that intersects with the ellipsoid.

The apparatus of the first aspect may include one or more of the previous embodiments and, optionally, that each nozzle of the plurality of nozzles is set in at least one of a particular orientation or a particular angle within the corresponding aperture based on a pre-determined spray pattern within the internal cavity defined within the inner cylinder.

The apparatus of the first aspect may include one or more of the previous embodiments and, optionally, a second plurality of nozzles. Each nozzle of the second plurality of nozzles is set within a particular aperture of a second plurality of apertures. Each nozzle of the second plurality of nozzles includes a body with at least one entry aperture within an entry end of the nozzle, an exit aperture within an exit end of the nozzle, and a basin in fluid communication with the at least one entry aperture and the exit aperture. Each nozzle of the second plurality of nozzles includes a cover with a plug that is insertable into the body, where the cover includes a surface that is substantially flush with a surface of the entry end of the nozzle.

A second aspect of the present disclosure is to provide an apparatus for a cleaning station. The apparatus includes an outer cylinder with a water inlet and at least one opening. The apparatus includes an inner cylinder with a plurality of apertures and at least one drain in fluid communication with a defined internal cavity, where the at least one drain exits through the at least one opening of the outer cylinder. The apparatus includes plurality of nozzles. Each nozzle of the plurality of nozzles is located within a particular aperture of the plurality of apertures. Each nozzle of the plurality of nozzles includes a body with at least one entry aperture within an entry end of the nozzle, an exit aperture within an exit end of the nozzle, and a basin in fluid communication with the at least one entry aperture and the exit aperture. Each nozzle of the plurality of nozzles includes a cover with a plug that is insertable into the body, where the cover includes a surface that is substantially flush with a surface of the entry end of the nozzle.

The apparatus of the second aspect may include, optionally, that a portion of the at least one entry aperture is formed by the cover and by the body.

The apparatus of the second aspect may include one or more of the previous embodiments and, optionally, that the basin includes a slot with two wings that meet at a central region proximate to the exit aperture.

The apparatus of the second aspect may include one or more of the previous embodiments and, optionally, that each wing increases in width as a distance from the exit aperture increases.

The apparatus of the second aspect may include one or more of the previous embodiments and, optionally, that the at least one entry aperture comprises two entry apertures, with each entry aperture of the two entry apertures corresponding to a particular wing of the two wings.

The apparatus of the second aspect may include one or more of the previous embodiments and, optionally, the at least one entry aperture comprises two entry apertures, with each entry aperture of the two entry apertures corresponding to a particular wing of the two wings.

The apparatus of the second aspect may include one or more of the previous embodiments and, optionally, that the plug of the cover includes a sloped surface that is insertable into the body. The sloped surface forms jet pathways within the basin between the at least one entry aperture to the exit aperture.

The apparatus of the second aspect may include one or more of the previous embodiments and, optionally, that the jet pathways generate an oscillating spray pattern within the internal cavity defined within the inner cylinder for fluid flowing through the basin between the at least one entry aperture and the exit aperture.

The apparatus of the second aspect may include one or more of the previous embodiments and, optionally, a second plurality of nozzles. Each nozzle of the second plurality of nozzles is set within a particular aperture of a second plurality of apertures. Each nozzle of the second plurality of nozzles includes an entry aperture within an entry end of the nozzle, an exit aperture within an exit end of the nozzle, and a basin in fluid communication with the entry aperture and the exit aperture. A first portion of the basin at the exit aperture is an approximately ellipsoid volume with an elliptical cross-section.

A third aspect of the present disclosure is to provide automated cleaning system. The system includes a pair of apparatuses. Each apparatus of the pair of apparatuses includes an outer cylinder with a water inlet. Each apparatus of the pair of apparatuses includes an inner cylinder with a plurality of apertures and at least one drain in fluid communication with a defined internal cavity. Each apparatus of the pair of apparatuses includes a first plurality of nozzles. Each nozzle of the first plurality of nozzles located within a particular aperture of the plurality of apertures. Each nozzle of the first plurality of nozzles includes a fan spray nozzle set in at least one of a particular orientation or a particular angle within the corresponding aperture based on a pre-determined spray pattern within the internal cavity defined within the inner cylinder. Each apparatus of the pair of apparatuses includes a second plurality of nozzles. Each nozzle of the second plurality of nozzles comprising an oscillating spray nozzle. Jet pathways within the oscillating spray nozzle generate an oscillating spray pattern within the internal cavity defined within the inner cylinder.

The apparatus of the third aspect may include, optionally, that the fan spray nozzle includes an entry aperture within an entry end of the fan spray nozzle, an exit aperture within an exit end of the fan spray nozzle, and a basin in fluid communication with the entry aperture and the exit aperture. A first portion of the basin at the exit aperture is approximately an ellipsoid with an elliptical cross-section.

The apparatus of the third aspect may include one or more of the previous embodiments and, optionally, that a second portion of the basin at the entry aperture is approximately a frustum with a frusto-conical cross-section, and that the frustum transitions into the ellipsoid between the entry aperture and the exit aperture.

The apparatus of the third aspect may include one or more of the previous embodiments and, optionally, that the oscillating spray nozzle includes a body with at least one entry aperture within an entry end of the oscillating spray nozzle, an exit aperture within an exit end of the oscillating spray nozzle, and a basin in fluid communication with the at least one entry aperture and the exit aperture. The body includes a cover with a plug that is insertable into the body, where the cover includes a surface that is substantially flush with a surface of the entry end of the oscillating spray nozzle.

The apparatus of the third aspect may include one or more of the previous embodiments and, optionally, that the plug of the cover includes a sloped surface that is insertable into the body. The sloped surface forms the jet pathways within the basin between the at least one entry aperture to the exit aperture.

The apparatus of the third aspect may include one or more of the previous embodiments and, optionally, that an inner surface of the outer cylinder substantially abuts an outer surface of the inner cylinder such that flow from the water inlet to the plurality of apertures is routed through grooves in the outer surface of the inner cylinder.

The apparatus of the third aspect may include one or more of the previous embodiments and, optionally, that each apparatus of the pair of apparatuses includes a conical portion and a barrel portion with a transition portion therebetween. The grooves are substantially located in the barrel portion of the apparatus. A radius of curvature of the transition portion is pre-determined to reduce flow pressure within the water inlet and increase a flow rate through the grooves to the plurality of apertures.

It is an aspect of the present disclosure to provide a wash system substantially as described herein.

It is an aspect of the present disclosure to provide an apparatus substantially as described herein.

These and other needs are addressed by the various embodiments and configurations of the present disclosure. The present disclosure is directed to novel apparatuses, nozzle longitudinal and circumferential distributions, and nozzle designs in an appendage wash system.

The present disclosure can provide a number of advantages depending on the particular configuration. The appendage wash system of the present disclosure can use a lower volume of water per appendage wash cycle than legacy systems. The apparatus of the present disclosure can hold less water per wash cycle due in part to the very low space between the inner and outer cylinders compared to legacy systems coupled with fluid flow channels for the wash solution. The appendage wash system can operate without a prime cycle. The nozzle designs of the present disclosure can maintain wash efficacy while reducing water consumption in part by reducing the force applied to the appendage during appendage washing. These and other advantages will be apparent from this disclosure.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about” or “approximately.” As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and claims themselves.

These and other advantages will be apparent from the disclosure contained herein. The above-described embodiments, objectives, and configurations are neither complete nor exhaustive. The Summary is neither intended nor should it be construed as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any feature or aspect described herein can be claimed in combination with any other feature(s) or aspect(s) as described herein, regardless of whether the features or aspects come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1 is a perspective view of a cleaning station, in accordance with one or more embodiments of the present disclosure;

FIG. 2A is a schematic depiction of a portion of the cleaning station depicted in FIG. 1, the cleaning station including an apparatus;

FIG. 2B is a perspective view of the apparatus shown in FIG. 2A;

FIG. 2C is an additional perspective view of the apparatus shown in FIG. 2A;

FIG. 2D is a close-up view of a portion of a cleaning station;

FIG. 3A is cross-sectional view of the apparatus and the seating assembly shown in FIG. 2A;

FIG. 3B is a first side elevation view of an inner cylinder of the apparatus of FIG. 3A;

FIG. 3C is a second side elevation view of an inner cylinder of the apparatus of FIG. 3A;

FIG. 3D is a third side elevation view of an inner cylinder of the apparatus of FIG. 3A;

FIG. 3E is a fourth side elevation view of an inner cylinder of the apparatus of FIG. 3A;

FIG. 4A is a cross-sectional view of the closed end of the apparatus and the seating assembly shown in FIG. 2A;

FIG. 4B is a detail view of a portion of FIG. 4A;

FIG. 5 is a cross-sectional view of a prior art apparatus;

FIG. 6 is an exploded view of the seating assembly shown in FIG. 2A;

FIG. 7 is an exploded perspective view of the apparatus of FIG. 2A;

FIG. 8A is a side view of an apparatus usable with the cleaning station depicted in FIG. 1, in accordance with one or more embodiments of the present disclosure;

FIG. 8B is a top view of the apparatus of FIG. 8A;

FIG. 8C is a bottom isometric view of the apparatus of FIG. 8A;

FIG. 8D is a side view of an inner cylinder of the apparatus of FIG. 8A;

FIG. 8E is a cross-sectional view of the apparatus of FIG. 8A illustrating exemplary spray patterns of various nozzles relative to an object;

FIG. 9A is a front view of a nozzle usable with the apparatus of FIG. 8A, the nozzle including a body, in accordance with one or more embodiments of the present disclosure;

FIG. 9B is a first side view of the nozzle of FIG. 9A;

FIG. 9C is a first cross-section of a first side view of the nozzle of FIG. 9A;

FIG. 9D is a second cross-section of a second side view of the nozzle of FIG. 9A;

FIG. 9E is a rear view of the nozzle of FIG. 9A;

FIG. 10A is a perspective view of a nozzle usable with the apparatus of FIG. 8A, the nozzle including a body and a cover, in accordance with one or more embodiments of the present disclosure;

FIG. 10B is a cross-section of the perspective view of FIG. 10A;

FIG. 10C is a perspective view of the cover of the nozzle of FIG. 10A;

FIG. 10D is a perspective view of the body of the nozzle of FIG. 10A;

FIG. 10E is a flow analysis diagram of fluid flow through the nozzle of FIG. 10A;

FIG. 11A is a flow analysis diagram of fluid flow through the apparatus of FIG. 2A;

FIG. 11B is a flow analysis diagram of fluid flow through the apparatus of FIG. 8A; and

FIG. 12 is an exploded perspective view of an apparatus for a cleaning station.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein. It is noted that any line in the drawings may be illustrated as solid or broken lines, including any section or length of each individual line, without departing from the scope of the present disclosure.

It will be appreciated that recitation of, for example, reference character 117, 117A, 117B, etc. may apply to any combination of reference characters 117, 117A, 117B, etc. In addition, it will be appreciated any reference characters “xx01”, “01”, and “1”, etc. within the figures and the description are referring to the same component within a system or operation of a method.

In the figures:

| Reference Number | Component |
|---|---|
| 100 | Automated Cleaning System |
| 104 | Housing |
| 108 | Apparatus |
| 200 | Hand |
| 204 | Drive Assembly |
| 208 | Drive Mechanism |
| 212 | Drive Belt |
| 216 | Seating Assembly |
| 220 | Receiving Basin |
| 222 | Basin Drain |
| 224 | Open End |
| 228 | Closed End |
| 232 | Water Inlet |
| 236 | Drain |
| 244 | Recessed Portion |
| 248 | Flange |
| 300 | Bottom Nozzle |
| 304 | Top Ring Nozzle |
| 308 | Helical Nozzle |
| 312 | Off-Helix Nozzle |
| 316 | Inner Cylinder |
| 320 | Outer Cylinder |
| 321 | Hole |
| 322 | Tubular Portion |
| 324 | Annular Cavity |
| 400 | Flow Arrow |
| 404 | Flow Arrow |
| 412 | Flow Arrow |
| 416 | Flow Arrow |
| 418 | Flow Arrow |
| 420 | Protrusion |
| 421 | Projection |
| 424 | Outer Surface |
| 428 | Inner Surface |
| 432 | Inner Wall |
| 436 | Sloped Surface |
| 500 | Cavity |
| 502 | Fluid |
| 504 | Inner Cylinder |
| 506 | Surface |
| 508 | Turbulence |
| 600 | Bearing |
| 604 | O-Ring |
| 608 | Bearing Block |
| 612 | Washer |
| 616 | Panel Nut |
| 700 | Protrusion |
| 704 | Hole |
| 708 | Recessed Portion |
| 712 | Hole |
| 714 | Flange |
| 716 | Drain Wall |
| 718 | Lip |
| 720 | Hole |
| 724 | Perforation |
| 732 | Hole |
| 800 | Apparatus |
| 804 | Outer Cylinder |
| 808 | Inner Cylinder |
| 812 | Fastener Port |
| 816 | Water Inlet |
| 820 | Outer Surface |
| 824 | Inner Surface |
| 828 | Inner Cylinder Cavity |
| 832 | Drain |
| 834 | Opening for Drain |
| 836 | Inner Wall |
| 840 | Groove |
| 844 | Aperture |
| 848 | Object Cleaning Region |
| 852 | Splashout Prevention Region |
| 900 | Primary Nozzle |
| 904 | Body |
| 908 | Entry Aperture |
| 912 | Entry End |
| 916 | Basin |
| 918 | Frustum Portion |
| 920 | Exit Aperture |
| 924 | Exit End |
| 928 | Ellipsoid Portion |
| 932 | Wedge Cut |
| 1000 | Secondary Nozzle |
| 1004 | Body |
| 1008 | Entry Aperture |
| 1012 | Entry End |
| 1016 | Basin |
| 1020 | Exit Aperture |
| 1024 | Exit End |
| 1028 | Cover |
| 1032 | Entry End Surface |
| 1036 | Cover Surface |
| 1040 | Plug |
| 1044 | Plug Surface |
| 1048 | Jet Region |
| 1052 | Stagnant Region |
| 1056 | Slot |
| 1058 | Wings |
| 1059 | Central Region |
| 1060 | Contoured Region of Body |
| 1064 | Cut |
| 1068 | Flow Analysis Diagram |
| 1100 | Flow Analysis Diagram |
| 1104 | Flow Analysis Diagram |
| 1108 | Frusto-Conical Portion of Apparatus |
| 1112 | Barrel Portion of Apparatus |
| 1116 | Transition Portion of Apparatus |
| 1200 | Apparatus |
| 1204 | Channel |
| 1208 | Inner Cylinder |
| 1212 | Outer Cylinder |
| 1216 | Nozzles |
| A | Arrow |
| D | Diameter |
| L | Length |
| RA | Rotational Axis |
| α | Angle |

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment of the improved appendage washing apparatus since describing every possible embodiment would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the improved appendage washing apparatus can be combined with dimensions, aspects, and features of another embodiment of the improved appendage washing apparatus to create the claimed embodiment.

Embodiments of the present disclosure are directed to one or more elements of a system and method for providing automated washing of an appendage of a person. In addition, it is to be understood that embodiments of the present application are also applicable to other types of washing systems, including for example, boot-washing systems. In accordance with embodiments of the present disclosure, cleaning effectiveness can be improved from that of traditional sink and faucet systems, as well as existing automated cleaning stations by using an automated cleaning station with an apparatus construction.

Cleaning stations operate to dispense one or more fluids (e.g., water, a cleaning fluid, a disinfectant, or the like) while a person's hands are placed in a washbasin. As used herein, a “washbasin” or “wash chamber” means a structure associated with the cleaning station where an appendage, such as a hand (or foot/boot) are cleaned, such as one or more apparatuses, spray areas, pans, tubs, etc. Individuals, such as employees of a laboratory, food service-related industry, or health care facility, may be instructed to wash their hands for a minimum amount of time that has been determined to be sufficient to provide a complete cleaning. In situations where hand (or boot) washing is required, or because of personal preferences, the user may be required to use (or otherwise desire to use) an automated cleaning station that incorporates an apparatus.

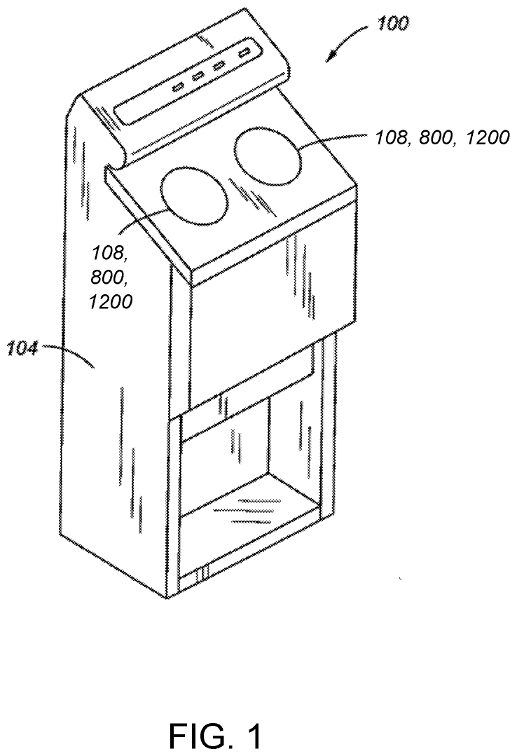

Referring now to FIG. 1, an automated cleaning system 100 (or automated cleaning station) is depicted. The cleaning system 100 includes a housing 104 and a pair of washbasins, and more preferably, apparatuses 108 residing within the housing 104 for receiving an object. As used herein an “object” may refer to anything cleaned by the automated cleaning station. An object may be, for example, an appendage of a user, a tool, a boot, and/or an inanimate object, etc. As used herein, “inanimate object” means an object that is principally not a biological tissue, although biological matter may be associated with the inanimate object, for example, a virus, bacteria, and/or pieces of tissue on a tool. For purposes of discussion, the various embodiments of the present disclosure are discussed herein in connection with cleaning an appendage of a user. However, it should be understood that the various embodiments may be used in connection with other objects.

The automated cleaning system 100 is shown as a free-standing machine. Alternatively, the automated cleaning system 100 may be incorporated into a countertop, wall, or other structure. Embodiments of the present disclosure include at least one washbasin that comprises an apparatus 108 that rotates around a user's hand to clean the user's hand. Although referred to and shown as a “cylinder,” the washbasin or wash chamber may comprise another shape. The cylinder may rotate either clockwise or counter-clockwise. Cleaning is performed by the application of fluids to the hands, wherein the fluids include but are not limited to water, a cleaning agent (such as soap), and/or a disinfectant (such as chlorhexidine gluconate (CHG)). The fluids are directed toward the user's hands through a series of nozzles, wherein the nozzles provide coverage of cleaning fluids to the user's hand to clean and rinse the user's hand.

In use, the user inserts an object (e.g., an appendage such as a hand) into the apparatus 108 and the cleaning system 100 automatically initiates a cleaning cycle by reading the presence of the user's hand within the apparatus 108, such as by an optical sensor.

At least one embodiment of the present disclosure is directed to a novel apparatus for use in automated hand-washing machines. The rotating cylinder construction is especially effective in providing a complete hand washing in a quick and reliable manner. In that regard, the rotating cylinders may be provided with a plurality of nozzle sets, such as a multi-set nozzle arrangement. At least one embodiment of the present disclosure features a novel orientation and arrangement of cylinder nozzles. Additionally, embodiments of the present disclosure include other novel features of an apparatus that provide for improved flow of water and/or cleaning fluid in and out of the cylinder.

When a person places his or her hands in the apparatuses 108, they are washed and/or disinfected in a series of steps. For example, within approximately ten seconds the hands may receive a (1) purge, (2) soap, and (3) rinse cycle. The purge cycle allows the water to reach the proper temperature. The soap cycle washes and allows the soap or disinfectant to kill germs. The rinse cycle removes the soap.

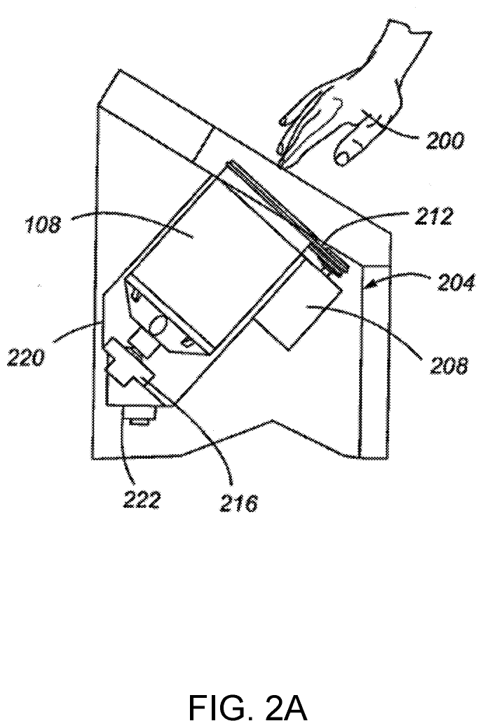

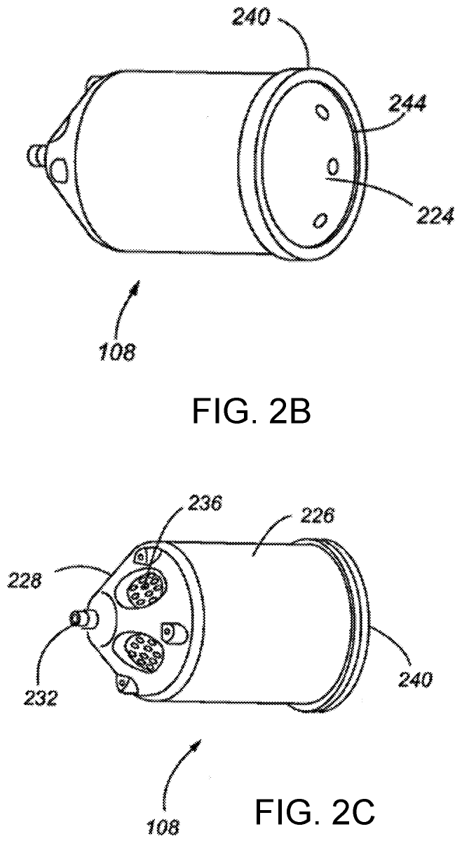

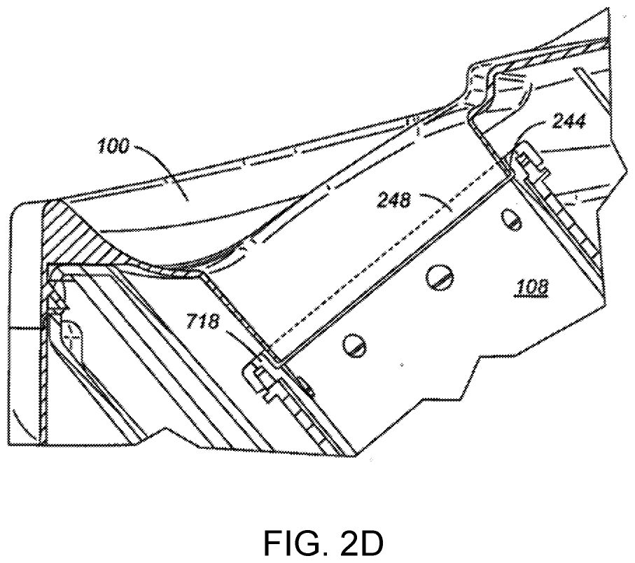

FIG. 2A provides a view of part of an exemplary automated cleaning system 100 used by an employee whose hand 200 is placed in position to be washed. One apparatus 108 and other components associated with the apparatus 108 can be seen in FIG. 2A. The apparatus 108 may be associated with a drive assembly 204 including a drive mechanism 208 and a drive belt 212. The drive assembly 204 operates to rotate the apparatus 108 when the automated cleaning system 100 is in use. As the apparatus 108 rotates, a plurality of nozzles disposed on the interior of the apparatus 108 spray water and/or cleaning fluid onto the hand 200. The apparatus 108 is interconnected to a seating assembly 216 that provides the apparatus 108 with a mounting within a receiving basin 220. As described in greater detail below, the receiving basin 220 receives spent water and/or cleaning fluid that drains out of the apparatus 108 after use in connection with washing or rinsing the hand 200. The spent fluid then exits through the basin drain 222 towards the sewer or other disposal system.

FIGS. 2B and 2C show detailed perspective views of the apparatus 108. The apparatus 108 includes an open end 224 and a frusto-conically shaped closed end 228. The closed end 228 includes a water inlet 232 and a plurality of drains 236. The open end 224 of the apparatus 108 features a rim 240 that includes a recessed portion 244. The recessed portion 244 is adapted to mate with a circular flange disposed on the automated cleaning system 100. The circular flange 248 can be seen with reference to FIG. 2D, which shows a close-up view of a portion of an automated cleaning system 100, including a top portion of the apparatus 108. As can be seen in FIG. 2D, the automated cleaning system 100 may include a circular flange 248 that is operatively associated with the recessed portion 244 of the cylinder. This arrangement prevents a person's fingers, and/or loose items, such as jewelry, from being caught between the rotating cylinder and non-moving portions of the automated cleaning system 100.

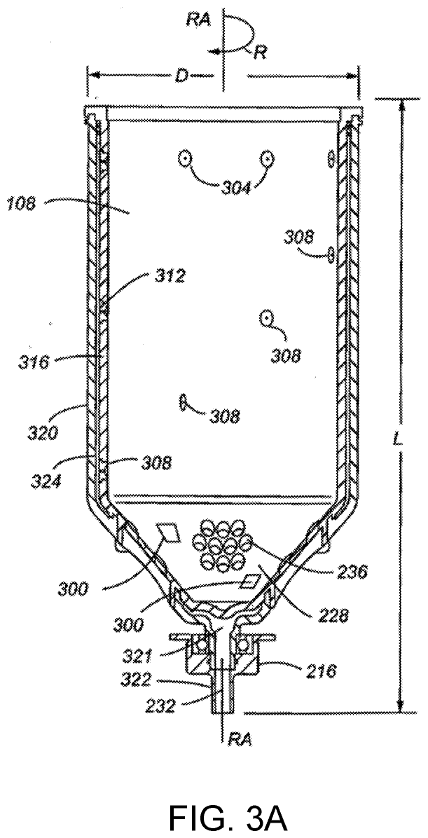

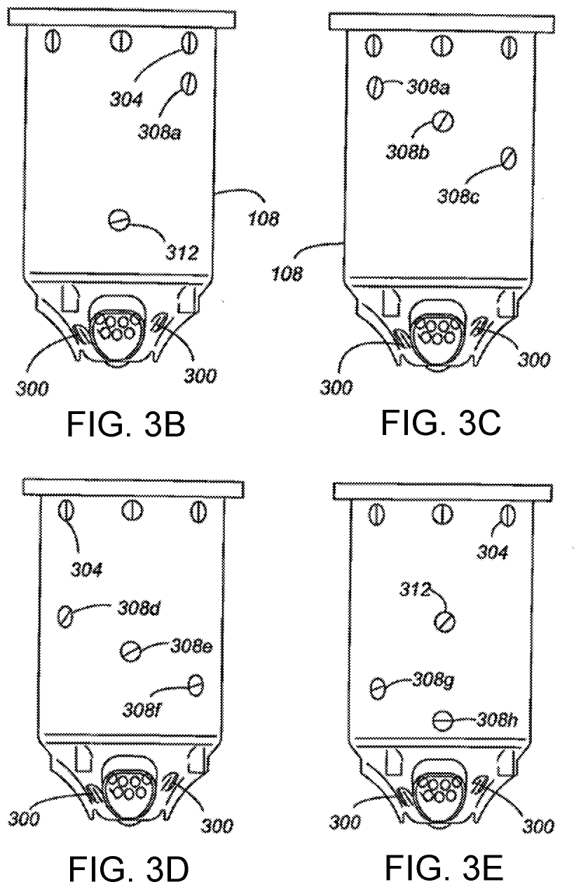

An understanding of the features of the appendage receiving member, such as apparatus 108, may be gained by an inspection of FIG. 3A, which depicts a cross-sectional view of the apparatus 108 and the seating assembly 216. Apparatus 108 preferably rotates around its rotational axis RA, such as in the direction of arrow R shown in FIG. 3A. The apparatus 108 includes nozzles arranged in a ring on the top end (the end proximate to the opening of the cylinder), nozzles arranged in a helical pattern along the length of the cylinder, one or more off-helix nozzles, and nozzles disposed on the bottom of the closed end of the cylinder. A portion of the complete arrangement of nozzles can be seen in FIG. 3A. In particular, bottom nozzles 300 are positioned on the closed end 228 of the apparatus 108. Top ring nozzles 304 are arranged just inside the open end 224 of the apparatus 108. Helical nozzles 308 are positioned in an array along the length of the apparatus 108. Four helical nozzles 308 are shown in FIG. 3A. However, it should be understood that the apparatus 108 may include additional helical nozzles 308 disposed on portions of the apparatus 108 that are not visible in the cross-sectional view shown in FIG. 3A. In particular, the complete apparatus 108 may include any number of helical nozzles, such as for example, five, six, seven, eight, nine, or ten. Additionally, the apparatus 108 includes one or more off-helix nozzles 312.

As can be seen in FIG. 3A, the apparatus 108 includes or comprises an appendage receiving member having an inner member, such as inner cylinder 316, and an outer member, such as outer cylinder 320. The appendage receiving member and its inner and outer member (where present) may be cylindrical or substantially cylindrical in shape, or may comprise another shape. An annular cavity 324 is established between the inner cylinder 316 and the outer cylinder 320. By way of example and not limitation, the annular cavity 324 may be approximately 0.070 inches wide. Alternatively, the annular cavity 324 may be between 1/16 inch and 3/16 inch wide. The length L of the apparatus 108 may be approximately 11.490 inches. Alternatively, the length L of apparatus 108 may be between approximately 12.5 and approximately 10.5 inches. The diameter D of the apparatus 108 may be approximately 6.580 inches. Alternatively, the diameter D of the apparatus 108 but may be between approximately 7.5 and approximately 5.5 inches. The above noted dimensions are example dimensions for an apparatus 108 used to clean a person's hands and are not meant to be limiting. Cylinders having different dimensions are within the scope of the present disclosure. For example, larger cylinders can be used to clean a person's hand, forearm, and upper arm. Also, as those skilled in the art will appreciate, different sized cylinders can be used to clean a person's foot and/or lower leg.

The nozzles discussed above are disposed on the inner cylinder 316. A complete nozzle arrangement can be seen with reference to FIGS. 3B-E, each of which shows the same inner cylinder 316 from a different viewpoint. The apparatus 108 shown in FIG. 3B-3E shows a nozzle arrangement having eight helical nozzles 308a-308h. The views shown in FIGS. 3B-E are 90 degrees apart, such that FIGS. 3B-E together show a complete 360-degree view of the inner cylinder 316. By way of illustration and not limitation, the inner cylinder 316 includes four bottom nozzles 300, eight top ring nozzles 304, eight helical nozzles 308a-308h, and two off-helix nozzles 312. It should be understood that alternative configurations of the apparatus 108 may include any suitable number of top ring nozzles 304, helical nozzles 308, off-helix nozzles 312, and bottom nozzles 300.

In operation, the annular cavity 324 established between the inner cylinder 316 and the outer cylinder 320 is filled with water and/or cleaning fluid under pressure. Fluid enters the annular cavity 324 through the fluid inlet 232 disposed on the closed end 228 of the apparatus 108. As best seen in FIG. 3A, the fluid inlet 232 includes a circular hole 321 in the outer cylinder 320 and a tubular portion 322 depending therefrom. Within a short time after initiating a cleaning cycle, the annular cavity 324 fills and becomes pressurized. The pressure within the annular cavity 324 forces the fluid through the nozzles 300, 304, 308a-308h, and 312 and into the interior of the apparatus 108. As a result, a spray pattern is established in the interior of the apparatus 108. Fluid is removed from the apparatus 108 through the drains 236 disposed on the closed end 228.

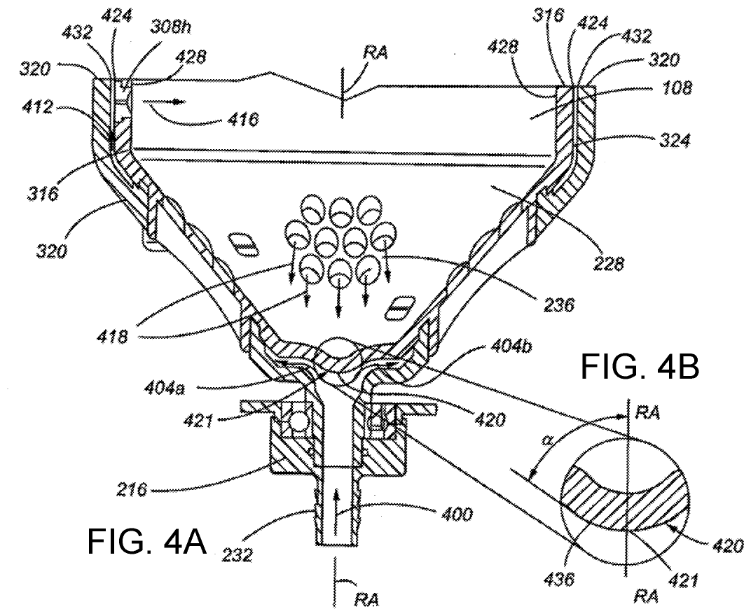

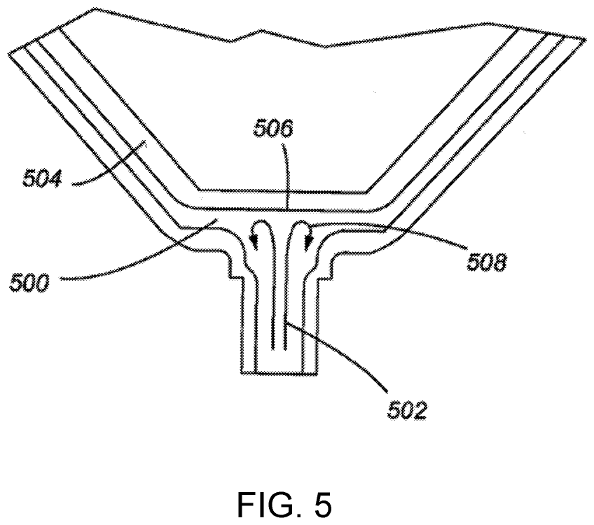

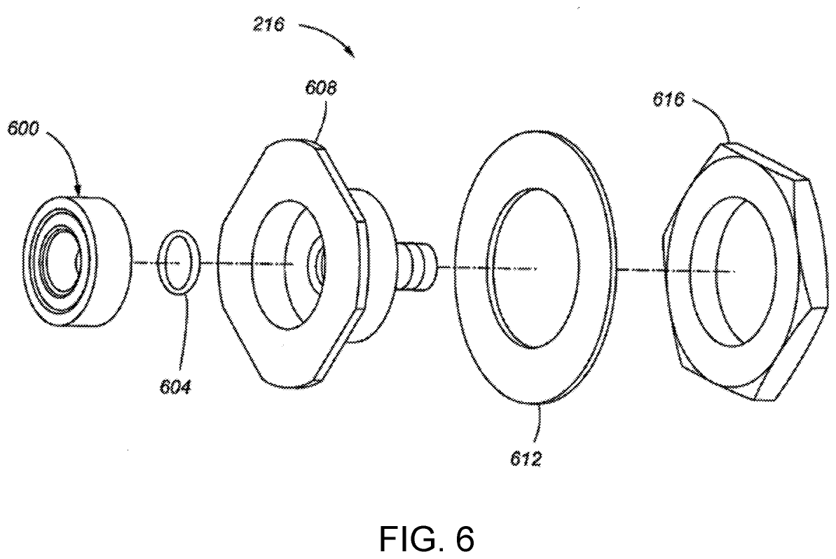

A more detailed understanding of the flow of fluid in and out of the apparatus 108 can be gained by an inspection of FIG. 4A, which shows a close-up view of the closed end 228 of an embodiment of an apparatus 108. In FIG. 4A, the inner cylinder 316 includes an outer surface 424 and an inner surface 428. The outer cylinder 320 includes inner wall 432.

Initially, as depicted by flow arrow 400, fluid enters through the fluid inlet 232. Then, as depicted by flow arrows 404a and 404b, the fluid flows into the annular cavity 324. It should be understood that as FIG. 4A is a cross-sectional view of the apparatus 108, only a portion of the fluid flow it depicted. In reality, the fluid flowing in from the inlet 232 spreads out in all directions to enter the annular cavity 324. When the annular cavity 324 fills and becomes pressurized, fluid is forced through the nozzles. The flow of fluid through one nozzle 308h is depicted in FIG. 4A. In particular, flow arrow 412 depicts flow into the nozzle 308h from the annular cavity 324 between the inner wall 432 of the outer cylinder 320 and the outer surface 424 of the inner cylinder 316, and flow arrow 416 depicts flow out of the nozzle 308h through the inner surface 428 of the inner cylinder 316 and into the interior of the apparatus 108. While FIG. 4A shows the flow of fluid through only one nozzle 308h, it should be understood that similar flow exists in other nozzles associated with the apparatus 108. After the fluid washes or rinses the hand 200, the fluid exits the apparatus 108 through the drains 236, as depicted by flow arrows 418. The spent fluid then enters the receiving basin 220 (shown in FIG. 2A) for drainage out of the system.

Referring still to FIG. 4A, the tip of the closed end 228 of the inner cylinder 316 includes a flow guidance structure or protrusion 420. The protrusion 420 is disposed on the inner cylinder 316 in line with the inlet 232. Fluid is deflected radially by the protrusion 420 as it enters through the inlet 232 into the cavity 324 between the inner cylinder 316 and the outer cylinder 320. This deflection serves to direct the flow of fluid and leads to a decreased level of turbulence in the fluid. FIG. 5 depicts the situation that results from fluid entering a cavity 500 without being deflected radially. In particular, the fluid 502 flows perpendicularly into a surface 506 of an inner cylinder 504. As a result of the turbulence created 508, the fluid 502 does not flow smoothly. This leads to a loss of fluid pressure and a longer time needed to fill the cylinder.

Referring again to FIG. 4A, as a result of the fluid guidance structure or protrusion 420, the cavity between the inner cylinder 316 and the outer cylinder 320 is filled and pressurized faster. More specifically, the protrusion 420 includes a symmetrical sloped surface that has its greatest location of projection 421 disposed in line with a central axis around which the apparatus 108 rotates. As shown in FIG. 4B, sloped surface 436 of protrusion 420 is offset from the rotational axis RA of the apparatus 108 by an angle α, where angle α is less than 90°. The speed in which the cavity is filled is important for delivering a complete hand washing in a timely manner. In particular, the cleaning system 100 utilizes a number of different cycles, such as wash and rinse, that require different fluids to flow in and out of the cylinder. As a result, it is advantageous to fill and pressurize the cavity 324 quickly in order to provide a smooth and fast transition between cycles. Additionally, the overall time needed to complete the total number of cycles is important for providing a reliable handwashing. It has been shown that people are more likely to wash their hands if the handwashing can be accomplished in a short period of time. Accordingly, for a number of reasons, a reduction in the time needed to fill and pressurize the cavity 324, as accomplished by the protrusion 420, achieves an improved and more desirable handwashing.

As spent fluid drains out of the apparatus 108 and into the receiving basin 220, the seating assembly 216 may become partially or totally submerged before the fluid exits through the basin drain 222. Accordingly, the seating assembly 216 is designed to operate in the presence of water and/or cleaning fluid. Components of the seating assembly 216 can be better seen in the exploded view shown in FIG. 6. As can be seen therein, the seating assembly 216 includes a bearing 600 and an O-ring 604 that are positioned within a bearing block 608. The bearing block is secured by means of a washer 612 and a panel nut 616 or other retaining hardware. The O-ring 604 operates to prevent fluid from entering the seating assembly 216. As a result, the connection between the apparatus 108 and the automated cleaning system 100 operates more effectively over a longer lifetime. Additionally, the O-ring 604 provides for a smoother connection when the apparatus 108 is mounted to the seating assembly 216, in comparison to previous friction-fit designs. Additionally, the O-ring 604 provides a seal between the bearing block 608 and the fluid inlet 232 preventing water and/or cleaning fluids from being lost in the receiving basin 220.

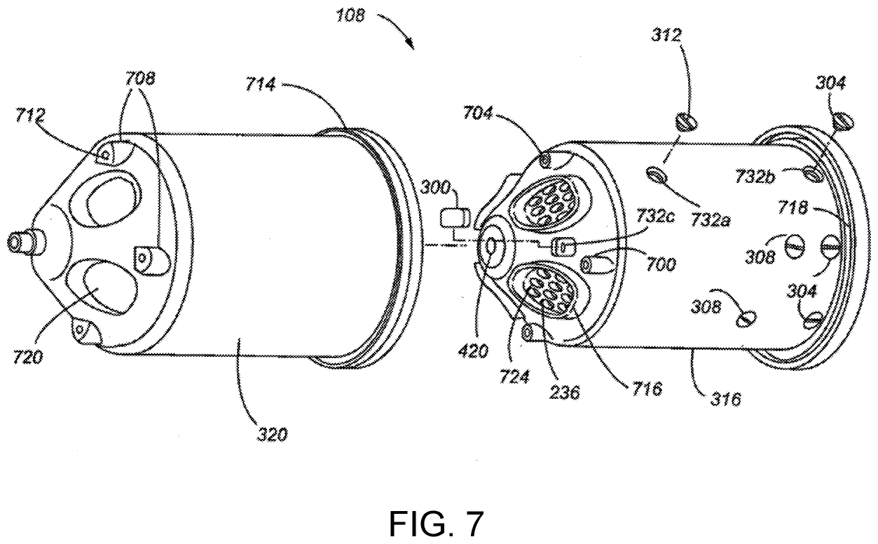

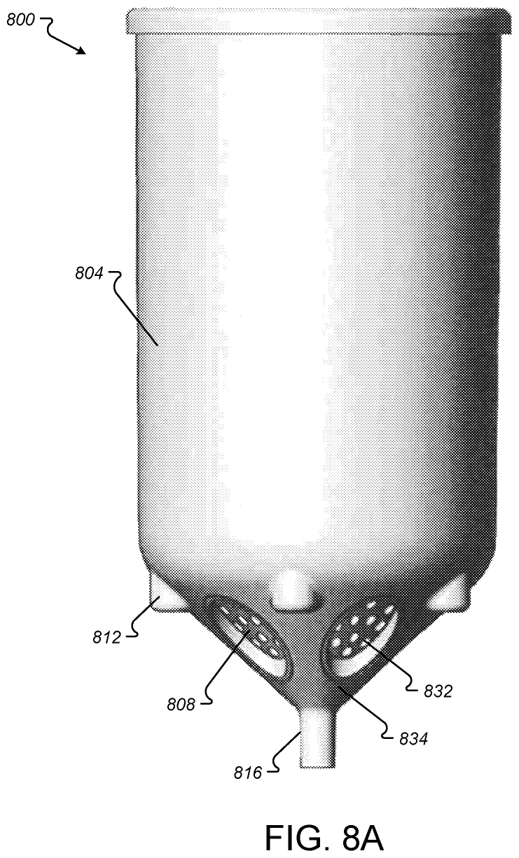

As described above, the appendage receiving member, such as apparatus 108, includes an inner member, such as inner cylinder 316, assembled to or integrated with an outer member, such as outer cylinder 320. As illustrated in the exploded view shown in FIG. 7, the apparatus 108 features a watertight seal between the inner cylinder 316 and the outer cylinder 320. In particular, the inner cylinder 316 includes protrusions 700 that contain holes 704 adapted to receive a connector, such as bolts or screws. The protrusions 700 are received in recessed portions 708 disposed on the outer cylinder 320. The inner cylinder 316 is interconnected to the outer cylinder 320 by screws that are driven through holes 712 in the recessed portions 708 into the holes 704 in the protrusions 700. Additionally, there are no hardware holes or protrusions on the inside of the inner cylinder that can cause harm to a user's hand. The watertight seal between the inner cylinder 316 and the outer cylinder 320 may include other connecting mechanisms such as rivets and/or glue.

Additionally, in order to provide a watertight seal between the inner cylinder 316 and the outer cylinder 320, the outer cylinder 320 includes a flange 714 that is adapted for engagement with a lip 718 disposed on the inner cylinder 316. An O-ring is positioned within the lip 718 to provide a seal between the inner cylinder 316 and the outer cylinder 320. The combination of the flange 714, lip 718 and the O-ring provides a seal that can resist high pressures exerted by fluid in the cavity between the cylinders 316 and 320. (e.g., the interconnection between the lip 718 and the flange 714 can be seen in FIG. 2D). Without this seal the cavity 324 may expand under high pressure conditions creating an opening between the cylinders 316 and 320 through which fluid may leak. A decreased fluid pressure will then be available at the nozzles and, accordingly, an inferior hand washing will result. Additionally, fluid leakage may result in unwanted fluid flow into portions of the automated cleaning system 100 that are unconnected to a drain 236 and/or are otherwise unable to receive fluid. Resulting fluid accumulation can lead to rust, electrical shorts, and/or other damage to components of the automated cleaning system 100. Accordingly, the seal structure described above provides a configuration that maintains fluid pressures and prevents undesirable leakage.

Referring still to FIG. 7, the drains 236 are disposed on the inner cylinder 316 and include a drain wall 716. When the inner cylinder 316 is connected to the outer cylinder 320, each drain wall 716 is received in, and protrudes through a hole 720 in the outer cylinder 320. An O-ring may be positioned around each drain wall 716 to provide a seal between the inner cylinder 316 and the outer cylinder 320. The surface of each drain 236 includes a plurality of perforations 724, which are large enough to allow fluid to pass through, and yet small enough to prevent a finger or small object from passing through. This drain configuration prevents a person's finger and/or their jewelry from being caught in the drain 236 when the apparatus 108 is in motion. In addition, the relatively small size of the perforations 724 prevents trash that may be deposited in the apparatus 108 from working its way into and clogging the drainage system.

As can be seen in the exploded view of FIG. 7, the nozzles associated with the apparatus 108 are connected to the inner cylinder 316. In particular, the inner cylinder 316 includes a plurality of shaped holes that are adapted to receive a nozzle of a particular shape. (Alternatively, the nozzle may simply be a slit in the in wall of the inner cylinder 316.) The top ring nozzles 304, the helical nozzles 308a-308h and the off-helix nozzles 312 have a “hat-shaped” construction adapted to fit in a similarly shaped hole in the inner cylinder. As can be seen in FIG. 7, an off-helix nozzle 312 is shown removed from its shaped hole 732a. Additionally, a top ring nozzle 304 is shown removed from its shaped hole 732b. The bottom nozzles 300 have a “square” construction. As can be seen in FIG. 7, a bottom nozzle 300 can be seen residing in its shaped hole 732c. In embodiments, the nozzles 300, 304, 308, 312 may be affixed in place within the holes 732 of the apparatus 108 via an adhesive.

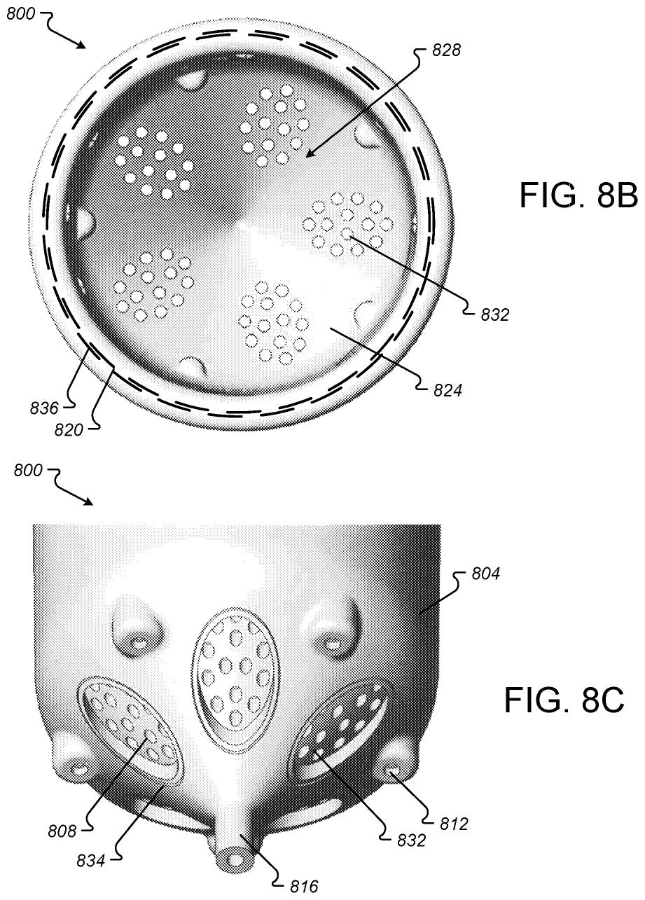

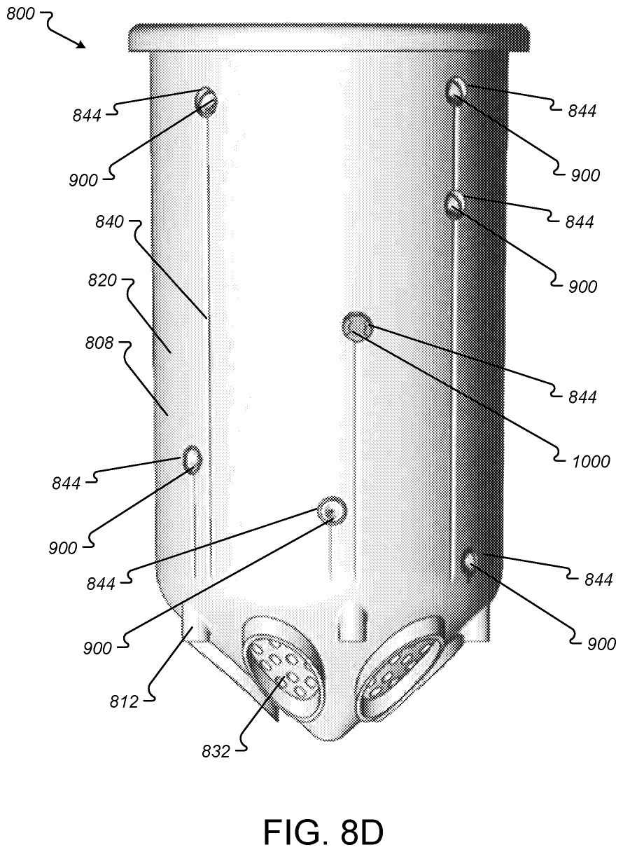

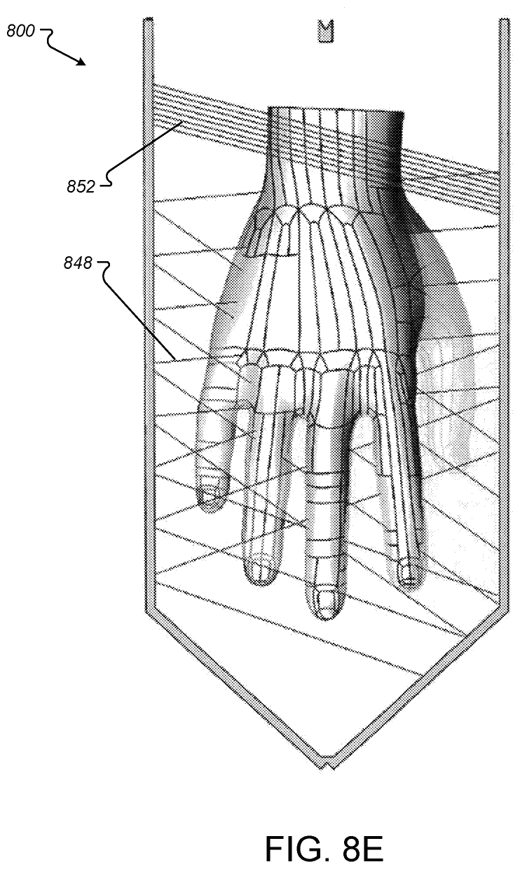

FIGS. 8A-8E illustrate an apparatus 800 that is interchangeable with the apparatus 108 for installation in the automated cleaning system 100, in accordance with one or more embodiments of the present disclosure. Unless otherwise noted, the apparatus 800 may include the same or similar design elements and features of the apparatus 108 of at least FIGS. 3A-3E. However, although there may be select shared features between the apparatus 108 and the apparatus 800, it is noted that the apparatus 800 provides a number of improvements over the apparatus 108. For example, the annular cavity 324 of the apparatus 108 fills with water and/or cleaning fluid between the inner cylinder 316 and the outer cylinder 320, which drains out between uses. This draining out of the water and/or cleaning fluid has two shortcomings which are addressed with the apparatus 800, including (1) excess waste of water and/or cleaning fluid, and (2) a delay in washing is not used continuously (e.g., draining may occur within 10 or 15 seconds from last use).

The apparatus 800 includes an outer cylinder 804 and an inner cylinder 808 that are secured together with fasteners through ports 812 in the outer cylinder 804 and the inner cylinder 808. As with the combination of the protrusions 700 with holes 704 and recessed portions 708 with holes 712 for connectors of the apparatus 108, the ports 812 are configured between the outer cylinder 804 and the inner cylinder 808 so that there are no hardware holes or protrusions on the inside of the inner cylinder 808 that can cause harm to the object. Alternatively, or in addition, to the fasteners a water-tight seal between the inner cylinder 808 and the outer cylinder 804 may include other connecting mechanisms such as rivets and/or glue.

To assist with generating the water-tight seal, and similar to the apparatus 108, the inner cylinder 808 and the outer cylinder 804 may include mating flanges and lips. An optional O-ring or other gasket that can resist high pressures may be located between (or proximate to) the flanges and lips. However, as discussed in detail further herein, it is contemplated that improvements to the apparatus 800 including the removal of backpressure at the water inlet 232 and reduction of volume for an annular cavity between the inner cylinder 808 and the outer cylinder 804 may reduce or eliminate the need for the mating flanges and lips, including optional O-ring or other gasket.

The outer cylinder 804 includes a water inlet 816 through which flow of water and/or cleaning fluid passes to nozzles within the inner cylinder 808. The nozzles are set within an outer surface 820 of the inner cylinder 808 and pass through sidewalls of the inner cylinder 808 to exit through an inner surface 824 of the inner cylinder 808 into a defined internal cavity 828.

Fluid in the cavity 828 exits the inner cylinder 808 through one or more drains 832 that pass through the outer cylinder 804 via openings 834. In some configurations, the drains 832 are integrally formed with the inner cylinder 808 (e.g., are regions of holes or other perforations within the inner cylinder 808).

Although embodiments of the disclosure illustrate five drains 832 that are circumferentially evenly distributed about the water inlet 816, it should be understood that the apparatus 800 may include more or fewer drains 832, without departing from the scope of the present disclosure. In addition, it should be understood that the apparatus 800 may include drains 832 that are unevenly distributed about the water inlet 816, without departing from the scope of the present disclosure.

To increase interchangeability of the apparatus 108, 800 in the system 100, an outer diameter of the outer cylinder 804 of the apparatus 800 is substantially similar to an outer diameter of the outer cylinder 320 of the apparatus 108. However, an outer diameter of the inner cylinder 808 may be increased as compared to an outer diameter of the inner cylinder 316, to reduce or eliminate annular cavities between the inner outer cylinder 804 and the inner cylinder 808 which can reduce or eliminate waste of water and/or cleaning fluid, while also reducing or eliminating downtime before washing may commence if the apparatus 800 is not used continuously.

To accommodate the increased diameter of the inner cylinder 808 while maintaining the outer diameter of the outer cylinder 804, a distance or spacing between an adjacent inner wall 836 of the outer cylinder 804 and the outer surface 820 of the inner cylinder 808 is decreased or substantially abuts one another. It should be understood that the spacing between the concentric circles representing outer surface 820 and inner wall 836 shown in FIG. 8B is merely provided for clarity, and should be not interpreted as limiting with respect to the present disclosure.

This decrease in distance reduces or eliminates most of the annular cavity 324 included in the apparatus 108 between the inner cylinder 316 and the outer cylinder 320. While the annular cavity 324 is used in the apparatus 108 for flow of water and/or cleaning fluid from the water inlet 232 to the nozzles 300, 304, 308, 312 of the apparatus 108, the flow of water and/or cleaning fluid from the water inlet 816 to the nozzles instead is generally isolated to recesses or grooves 840 in the outer surface 820 of the inner cylinder 808.

In some configurations, the grooves 840 are aligned with (and provide or route water and/or cleaning fluid to) apertures 844 in the outer surface 820 of the inner cylinder 808, where the apertures 844 are configured to receive nozzles as discussed in detail further herein. As illustrated in FIGS. 8A-8E, the apparatus 800 may use the grooves 840 in the inner cylinder to direct water more efficiently without requiring a large area of water to be filled (e.g., like the annular cavity 324). The geometry of the water flow path in the cylinder is thus substantially increased (or optimized) to increase (or maximize) fluid velocity. In one non-limiting example, the volume of water typically required to fill the apparatus 800 has decreased from approximately 0.3 gallons in the design of the apparatus 108 in FIG. 3A to about 0.015 gallons for the apparatus 800 in FIG. 8A.

The increased fluid velocity reduces (or practically eliminates) the need to prime the apparatus 800 (i.e., the time it takes to fill the apparatus 800 before water and/or cleaning fluid begins to spray from the nozzles). In addition, the flow rate is reduced from between approximately 2.25 and approximately 3 gallons per minute for each apparatus 108 in the system 100, to a flow rate of between approximately 1.5 and approximately 2 gallons per minute for each apparatus 800 in the system 100, without observing loss in nozzle spray velocity.

In embodiments, the inner cylinder 808 may include nozzles of one or more designs. Generally, the apparatus 800 may include any combination of various fan nozzles (e.g., nozzles 300, 304, 308, 312, 900) and oscillating nozzles (e.g., nozzle 1000). As will be appreciated, oscillating nozzles use alternating low- and high-pressure cycles with a suitably designed inner flow chamber to cause an emitted water stream to oscillate back and forth in a desirable spray pattern (e.g., an “S” pattern) as it escapes the nozzle. The larger droplet size created by oscillating nozzles can have more mass and increased impact force, thereby enabling better cleaning results at lower pressure with reduced water usage. Different nozzles can be utilized in different areas to perform specific tasks such as general cleaning, splash-out prevention, finder tips and nails, purlicue/crook of thumb, and wrist. For example, FIG. 8E illustrates an arrangement of nozzles that generates a first spray pattern in an object cleaning region 848 (e.g., proximate to the palm and fingers of the hand) and a second spray pattern in a splashout prevention region 852 (e.g., proximate to the wrist).

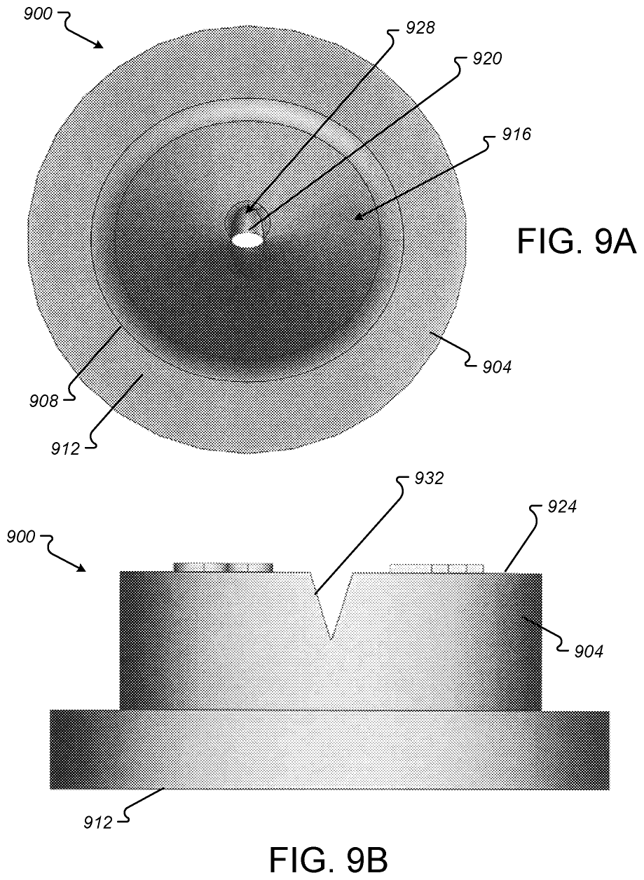

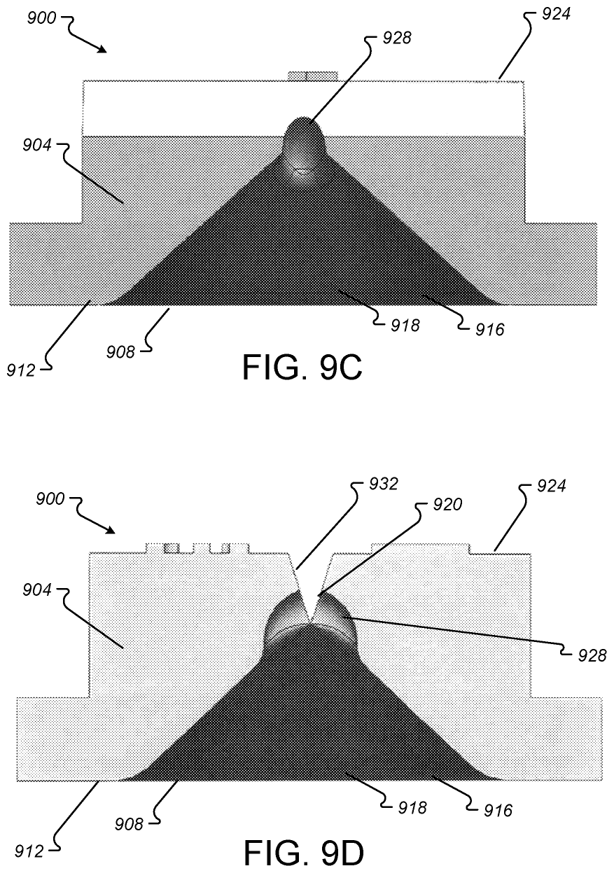

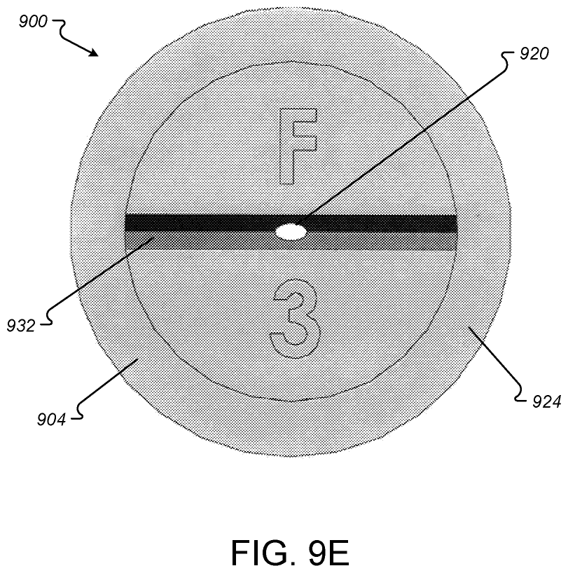

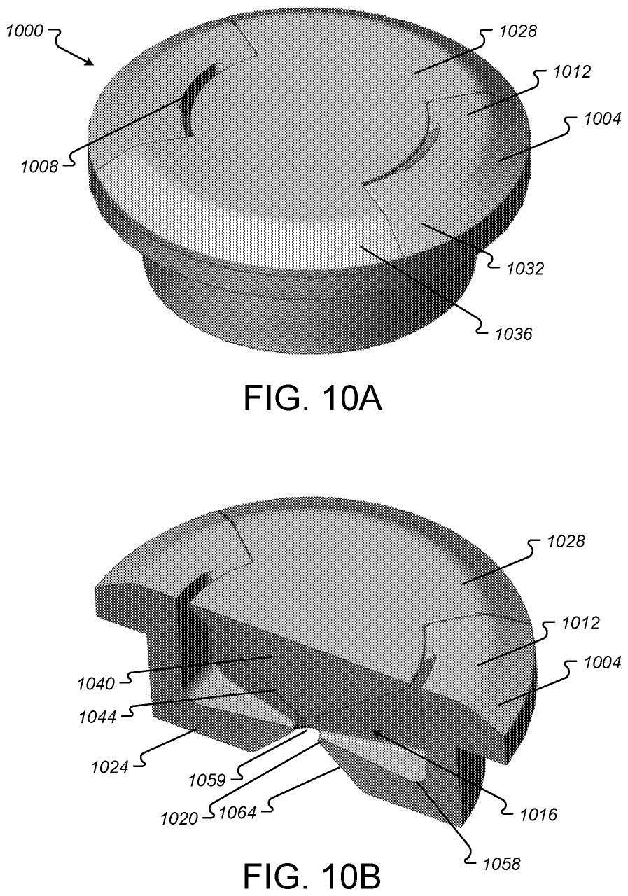

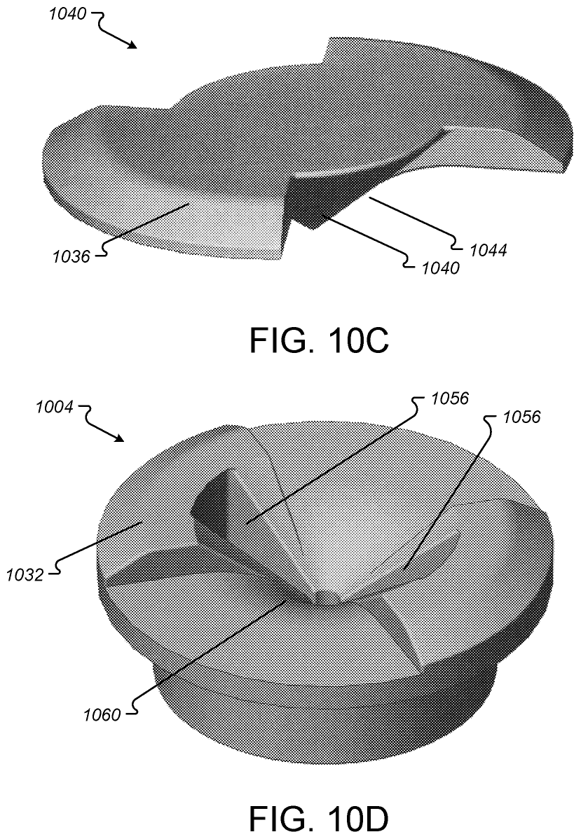

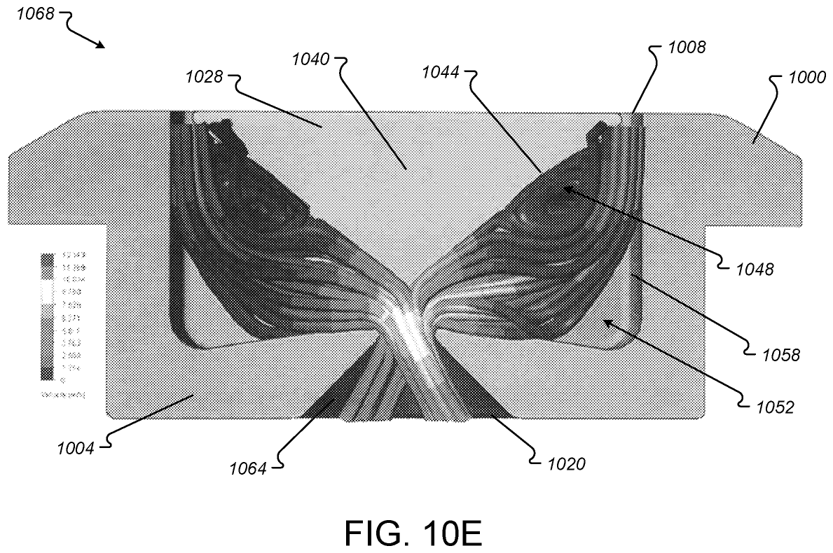

In some configurations, the apertures 844 of the inner cylinder 808 may be dimensioned to receive nozzles, which are inset within the apertures 844 at any pre-determined angle to adjust the direction of the spray pattern within the cavity 828 of the inner cylinder 808 (e.g., to form the various spray pattern regions as non-limitingly illustrated in FIG. 8E). For example, the apertures 844 may be dimensioned to receive an improved primary nozzle 900, as illustrated in FIGS. 9A-9E. Further, FIGS. 10A-10E illustrate a further nozzle type, namely a secondary oscillating nozzle 1000, that is dimensioned to be insertable into the apertures 844 of the apparatus 800. It is also contemplated that the apertures 844 may be dimensioned to receive nozzles similar to one or more of the bottom nozzles 300, the top ring nozzles 304, the helical nozzles 308, and/or the off-helix nozzles 312 as described with respect to FIGS. 3A-3E, without departing from the scope of the present disclosure.

In one non-limiting example of a layout of nozzles, FIG. 9D illustrates a plurality of nozzles 900 in apertures 844 around the circumference of the inner wall 824 of the inner cylinder 808, and one or more nozzles 1000 in apertures 844 at select locations within the inner wall 824. However, it is contemplated that the apparatus 800 may include any combination of nozzles (e.g., nozzles 300, 304, 308, 312, 900, 1000) as described throughout the present disclosure.

Referring now to FIGS. 9A-9E, the nozzle 900 is a fan spray nozzle that is usable in the apertures 844 of the apparatus 800. The nozzle 900 includes a body 904 with an entry aperture 908 in an entry end 912 that receives the water and/or cleaning fluid, a basin 916 that at least temporarily stores the water and/or cleaning fluid as the water and/or cleaning fluid passes through the nozzle 900, and an exit aperture 920 in an exit end 924 opposite the entry end 912.

In some configurations, the primary nozzle 900 is improved (or optimized) over nozzles 300, 304, 308, 312 using finite element analysis (FEA) to obtain increased (or maximum) impaction, thus increasing (or maximizing) force on the object during cleaning, while maintaining an adequate coverage of the object. To accomplish this, an exit aperture 920 of the nozzle 900 is reduced in shape and modified in shape as compared to the nozzles 300, 304, 308, 312.

In embodiments, as illustrated in FIGS. 9C and 9D, at least a portion of the basin 916 is an approximately a frustum 918 with a frusto-conical cross-section. In addition, at least a portion of the basin 916 is an approximately an ellipsoid 928 proximate to the exit aperture 920, where the frustum 918 portion of the basin 916 transitions from the entry aperture 908 to the ellipsoid 928 portion at the exit aperture 920. The ellipsoid 928 includes an elliptical cross-section with a larger major axis and a smaller minor axis.

In embodiments, the exit aperture 920 is formed by a wedge cut 932 in the exit end 924, through which the water and/or cleaning fluid flows after passing through the ellipsoid 928. The wedge cut 932 intersects with the ellipsoid 928 to form in the exit aperture 920, which is optionally elliptical in shape with a major axis aligned in a lengthwise direction with the wedge cut 932, as illustrated in FIG. 9E.

It is noted that the combination of the ellipsoid 928 and the wedge cut 932 to form the elliptical exit aperture 920 reduces the possibility of flow localization through the exit aperture 920, as compared to a square hole fluidly connected to a spherical region which would have a weak flow pattern in the middle and pronounced flow patterns near the outer perimeter. It is noted that the nozzle 900 may include a wedge cut 932 with sides that are set at between approximately 5 degrees and approximately 175 degrees (e.g., as viewed from a side cross-section). In some configurations, the sides of the wedge cut 932 may be set at between approximately 30 degrees and 40 degrees (e.g., as viewed from the side cross-section).

Where there are multiple nozzles 900 in the apparatus 800, it is contemplated that at least some of the multiple nozzles 900 may be installed with the wedge cut 932 at the same or different angle and/or rotation into the cavity 828, to allow for the ability to adjust the spray pattern from the nozzle 900 within the cavity 828. In addition, where there are multiple nozzles 900 in the apparatus 800, it is contemplated that at least some of the multiple nozzles 900 may be fabricated with the same or different angle for the wedge cut 932.

Referring now to FIGS. 10A-10E, the nozzle 1000 is an oscillating nozzle that is usable in a pre-determined or select number of the apertures 844 of the apparatus 800. The nozzle 1000 includes a body 1004 with at least one entry aperture 1008 in an entry end 1012 that receives the water and/or cleaning fluid, a basin 1016 that at least temporarily stores the water and/or cleaning fluid as the water and/or cleaning fluid passes through the nozzle 1000, and an exit aperture 1020 in an exit end 1024 opposite the entry end 1012.

In embodiments, the nozzle 1000 includes a cover 1028. In some configurations, the at least one entry aperture 1008 is formed between surfaces 1032 of the entry end 1012 and a surface 1036 of the cover 1028. It is noted that the surfaces 1032, 1036 may be substantially flush and/or may be contoured to assist in directing flow into the at least one entry aperture 1008, without departing from the scope of the present disclosure. In one non-limiting example, the cover 1028 and the body 1004 may each form portions of the two entry apertures 1008 that lead to the same basin 1016.

The cover 1028 includes a plug 1040 that is insertable into the entry end 1012. In some configurations, the plug 1040 is tapered (e.g., with a frusto-conical cross-section) with surfaces 1044 to assist in directing fluid flow through the basin 1016 from the at least one entry aperture 1008 to the exit aperture 1020.

In embodiments, the basin 1016 is configured to generate an oscillatory flow for the water and/or cleaning fluid through the basin 1016 between the at least one entry aperture 1008 to the exit aperture 1020. As illustrated in a flow diagram 1068 in FIG. 10E, fluid flow through the basin 1016 includes jet pathways or jet regions 1048 more proximate to the surfaces 1044 of the cover 1028, and lower-flow or stagnant regions 1052 in the further regions of the basin 1016 from the surfaces 1044. This is due to the frusto-conical cross-section of the plug 1040 generating a negative whirlpool to balance spraying in one direction, and then another direction, to produce the oscillatory fan movement of the water and/or cleaning fluid through the exit aperture 1020.

In embodiments, as illustrated in FIG. 10D, the basin 1016 is formed from two slots 1056 that optionally have separate entry apertures 1008 and that meet at the same exit aperture 1020 at a center point of the body 1004. In some configurations, the width of the slot 1056 increases in width from the center point of the body 1004 as the circumference of the body 1004 increases, to a pre-determined point where the slot 1056 terminates at the entry end surface 1032.

As the two slots 1056 exit the same exit aperture 1020, it is noted the basin 1016 may be considered a single slot with two wings 1058 that meet at a central region 1059 proximate to the exit aperture 1020 and are aligned along a major axis, where the wings 1058 each increase in width as the distance along the major axis from the exit aperture 1020 increases in each direction toward the respective entry aperture 1008.

To assist in directing water and/or cleaning fluid through the entry apertures 1008 and into the slots 1056, the body 1004 may include a contoured region 1060 that is configured to receive the plug 1040 of the cover 1028. In particular, the plug 1040 may nest within the contoured region 1060 to allow for the entry end surface 1032 of the body 1004 and the cover surface 1036 of the cover 1028 to be substantially flush, increasing the directing or isolating of water and/or cleaning fluid flow through the entry apertures 1008 and into the slots 1056.

In embodiments, the exit aperture 1020 is formed by a cut 1064 in the exit end 1024, through which the water and/or cleaning fluid flows after passing through the basin 1016. In some configurations, the cut 1064 is a countersink with a circular cross-section from the bottom (or triangular cross-section from the side) that forms the exit aperture 1020 by intersecting with the basin 1016. In other configurations, the cut 1064 is a slot with a major axis that is aligned with a major axis through the basin 1016, including optionally with an increase in width from the center point of the body 1004 as the circumference of the body 1004 increases. It is noted that the nozzle 1000 may include a cut 1064 with sides that are set at between approximately 5 degrees and approximately 175 degrees (e.g., as viewed from the side cross-section). In some configurations, the sides of the cut 1064 may be set at between approximately 85 degrees and 95 degrees (e.g., as viewed from the side cross-section).

In one non-limiting example, the nozzle 1000 may be configured as a Coanda-effect fluidic oscillator. Here, a jet entering the basin 1016 attaches to a contoured surface (e.g., one of the surfaces 1044 of the plug 1040 or an inner sidewall of one of the wings 1058) and biases the emitted stream toward one side of the exit aperture 1020. A feedback mechanism periodically detaches the jet and causes it to reattach on the opposite side, with the cycle repeating at a frequency set by the geometry of the basin 1016, the volumetric flow rate, and the supply pressure. For example, the feedback mechanism may be formed by one of the wings 1058, the central region 1059, a feedback channel in the body 1004 or the cover 1028, and/or interaction between the attached jet and a counter-flow region within the opposing wing 1058.

In another non-limiting example, the nozzle 1000 may be configured as a Helmholtz fluidic oscillator. Here, the basin 1016 (alone or in combination with one or more chambers formed in the body 1004 or beneath the plug 1040) defines one or more resonant cavities that, together with a constricting passage (e.g., the exit aperture 1020, the cut 1064, or a passage between one of the slots 1056 and the central region 1059 acting as a resonator neck), form a Helmholtz resonator tuned to a target frequency. Periodic compression and expansion of fluid within the resonant cavity modulates discharge through the exit aperture 1020. In some configurations, two resonant cavities (e.g., one within each of the wings 1058) are fluidly coupled through the central region 1059 to oscillate out of phase and alternately discharge fluid to produce the side-to-side sweep of the emitted stream.

It is further contemplated that the nozzle 1000 may be configured as another type of fluidic oscillator without departing from the scope of the present disclosure, including, by way of non-limiting example, a wall-attachment oscillator with one or more feedback channels, a jet-interaction oscillator in which opposing jets impinge within the basin 1016, a vortex-shedding oscillator driven by the geometry of the plug 1040 and the surfaces 1044, or a hybrid combining features of two or more of the foregoing. In embodiments, the nozzle 1000 produces an oscillation frequency between approximately 10 Hz and 1,000 Hz at a supply pressure between approximately 10 psi and approximately 100 psi, with a fan angle at the exit aperture 1020 between approximately 30 and approximately 120 degrees, although these ranges should be considered non-limiting for purposes of the present disclosure.

In general, the nozzles 1000 (and corresponding apertures 844) may be strategically placed in pre-determined locations in the inner cylinder 804 to increase (or maximize) impaction). In one non-limiting example, the nozzle 1000 may be located within the inner cylinder 804 to provide a spray pattern for the thumb of the hand of the user inserted into the apparatus 800, as illustrated in FIG. 8D. By way of another example, the nozzles 1000 may be located proximate to the wrist to create a splashout prevent region 852, as illustrated in FIG. 8E.

Where there are multiple nozzles 1000 in the apparatus 800, it is contemplated that at least some of the multiple nozzles 1000 may be installed with the wedge cut 1064 at the same or different angle and/or rotation into the cavity 828, to allow for the ability to adjust the spray pattern from the nozzle 1000 within the cavity 828. In addition, where there are multiple nozzles 1000 in the apparatus 800, it is contemplated that at least some of the multiple nozzles 900 may be fabricated with the same or different number of entry apertures 1008, basin 1016 configuration, and/or cross-section for the plug 1040.

In embodiments, the nozzles 900, 1000 may be inserted within the apparatus 800 using a retainment system allows for the removal and replacement of the nozzles 900, 1000 (e.g., as compared to an adhesive, as used in the apparatus 108). For example, the nozzles 900, 1000 may be molded in silicone, include interlocking features like complementary threading with the apertures 844, or utilize another retainment system. In some configurations, the nozzles 900, 1000 may be keyed with the apertures 844 in a particular orientation and/or particular angle, to generate a pre-determined or desired spray pattern within the cavity 828 of the inner cylinder 808.

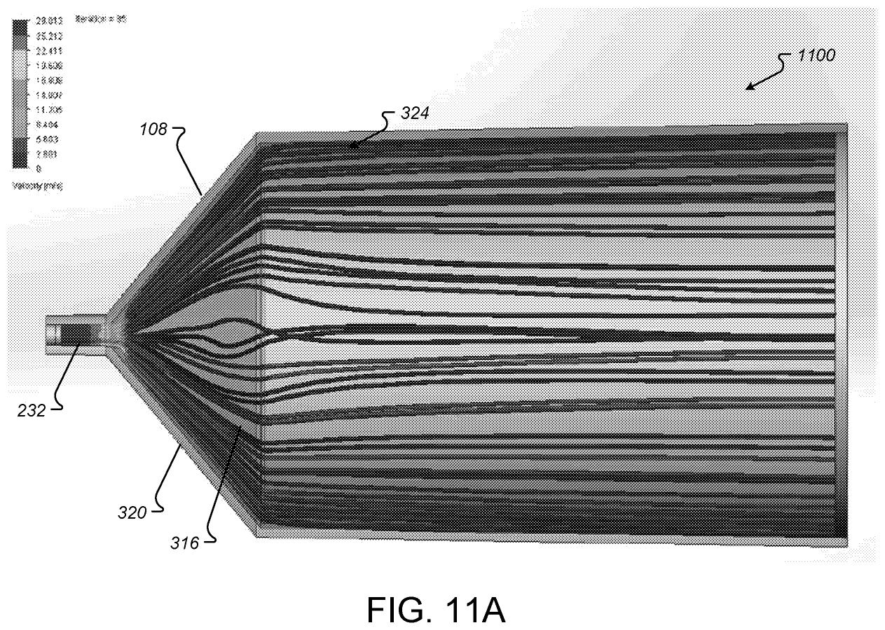

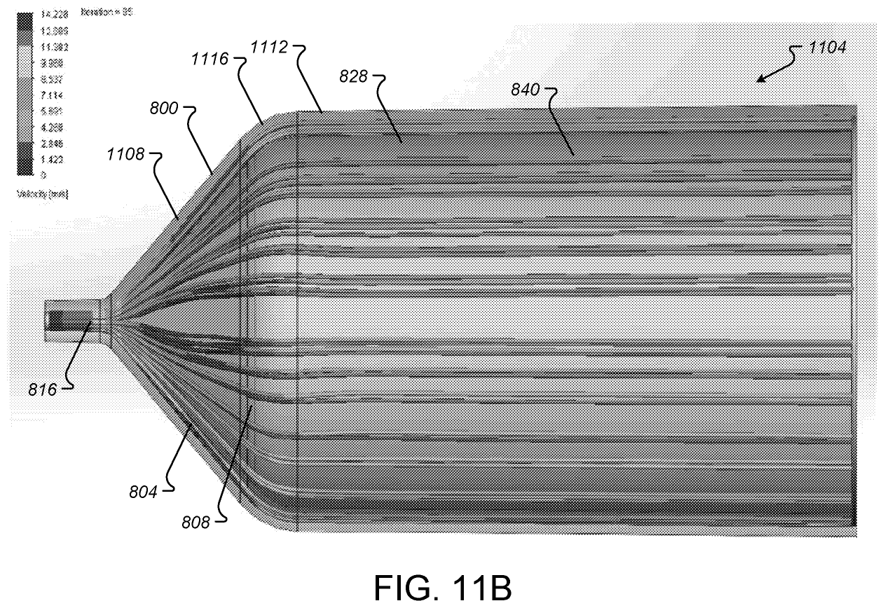

FIGS. 11A and 11B illustrate a comparison between flow through the apparatus 108 and the apparatus 800. In particular, FIG. 11A is a flow of fluid (e.g., water and/or cleaning fluid) through the apparatus 108, and FIG. 11B is a flow of fluid through the apparatus 800.

As illustrated in FIG. 11A, flow through the apparatus 108 passes through the water inlet 232 before entering the annular cavity 324 between the inner cylinder 316 and the outer cylinder 320 to ultimately exit into the inner cylinder 316 through the nozzles in holes 732 (not shown). Although the flow is illustrated as individual streams, that is merely for illustration—rather, it should be understood that the entire annular cavity 324 is filled with water and/or cleaning fluid from the water inlet 232.

The design of the inner cylinder 316 and the outer cylinder 320 creates a bottlenecked flow within the water inlet 232, resulting in increased pressure in the water inlet 232 and reduced pressure through the annular cavity 324. As a result, increased water velocity (e.g., driven by pressure) and volume is necessary throughout the apparatus 108, in order to provide a sufficient or desired cleaning by the nozzles of the object when inserted in the inner cylinder 316.

For example, the flow analysis diagram 1100 illustrates a gradient of flow rate between approximately 0 and approximately 91.86 feet per second (between approximately 0 and approximately 28.013 meters per second) at the water inlet 232 and in the annular cavity 324. The greatest flow rate at the water inlet 232 and nearly 0 velocity in the annular cavity 324.

As illustrated in FIG. 11B, flow through the apparatus 800 passes through the water inlet 816 before entering the grooves 840 within the outer surface 820 of the inner cylinder 316 and ultimately exiting into the cavity 828 of the inner cylinder 316 through the nozzles in apertures 844 (not shown). However, as illustrated in a comparison between the apparatus 108 and the apparatus 800, a transition between a frusto-conical portion 1108 and a barrel portion 1112 of the apparatus 800 is updated or optimized, as compared to corresponding regions of the apparatus 108. For example, the apparatus 800 includes a transition portion 1116 between the frusto-conical portion 1108 and the barrel portion 1112, each illustrated both on the outer cylinder 804 in FIG. 8A and on the inner cylinder 808 in FIG. 8D, where the transition portion 1116 includes a rounded corner that defines an arc having a radius of curvature. In contrast, the apparatus 108 includes a defined corner for the transition between a frusto-conical portion and a barrel portion, which does not include an arc having a radius of curvature.

The updated or optimized design of the transition portion 1116 of the inner cylinder 808 and the outer cylinder 804 of the apparatus 800 reduces the bottlenecked flow through the water inlet 816 as compared to the bottlenecked flow through the water inlet 232 by the corner of the apparatus 108, resulting in decreased pressure in the water inlet 816 and increased pressure through the grooves 840 for the apparatus 800. As a result, decreased water velocity (e.g., driven by pressure) and volume is necessary throughout the apparatus 800, in order to provide the same or better level of cleaning by the nozzles of the object when inserted in the cavity 828.

For example, the flow analysis diagram 1104 illustrates an approximately 50% reduction in flow rate, with a gradient of flow rate between approximately 0 and approximately 46.68 feet per second (between approximately 0 and approximately 14.228 meters per second) at the water inlet 816 and in the grooves 840. Although the greatest flow rate is still at the water inlet 232, there is an improved non-zero velocity through the grooves 840 of approximately 11.48 feet per second (3.5 meters per second) through the barrel portion 1112 of the apparatus 800. As such, the apparatus 800 includes improved fluid delivery to the nozzles with a lower fluid pressure.

For some configurations of the apparatus 108 and the apparatus 800, Table 1 illustrates a comparison, using pounds per square inch (psi) and gallons per minute (GPM) of a set of non-limiting example configurations for the apparatus 108 versus the apparatus 800:

TABLE 1

| | Apparatus 108 | Apparatus 800 |
|---|---|---|
| Pressure at | Approximately 12 psi | Approximately 20 psi |
| Cylinder | | |
| Pressure to | Approximately 40 psi | Approximately 30 psi |
| System | | |
| Apparatus Flow | Approximately 2.35 GPM | Approximately 1.5 GPM |
| Bay Flow | Approximately 4.70 GPM | Approximately 3.0 GPM |
| Number of | 20 Nozzles | 13 Nozzles |
| Nozzles Per | | |
| Apparatus | | |
| Waste Through | 0.08 gallons | 0.015 gallons |
| Apparatus Drain | | |
| Waste Through | 0.16 gallons | 0.030 gallons |
| System Drain | | |

As provided in Table 1, the apparatus 800 observes a higher pressure for the nozzles (pressure at cylinder) with a lower pressure in the system 100 (pressure at system). In addition, the flow rate through the apparatus 800 is decreased through a fewer number of nozzles (through the number of nozzles may change depending on desired spray pattern), which also reduces the total flow rate needed for the system 100 (having two apparatuses 800). Further, the waste from the apparatus 800 is reduced, having less space between the inner and outer cylinders (e.g., grooves 840 of the apparatus 800 instead of the larger annular cavity 324 of apparatus 108), which also reduces the total waste from the system 100 (having two apparatuses 800).

In one comparison, the apparatus 108 and the apparatus 800 may each include two different types of nozzles. In the apparatus 108, the wrist and helical nozzles may include 16 fan nozzles that each require 0.125 GPM, and the fingertip nozzles may include 4 fan nozzles that each require 0.08 GPM. In contrast, in the apparatus 800 the wrist/splashout nozzles include 4 nozzles that each require 0.08 GPM, and the fingertip nozzles may include 9 nozzles that each require 0.14 GPM. In this comparison, a reduction of approximately 36% in flow rate is observed in the system 100 when using the apparatus 800 versus using the apparatus 108. In addition, an increase of nozzle impact force of approximately 48% is observed when using the apparatus 800 versus using the apparatus 108.

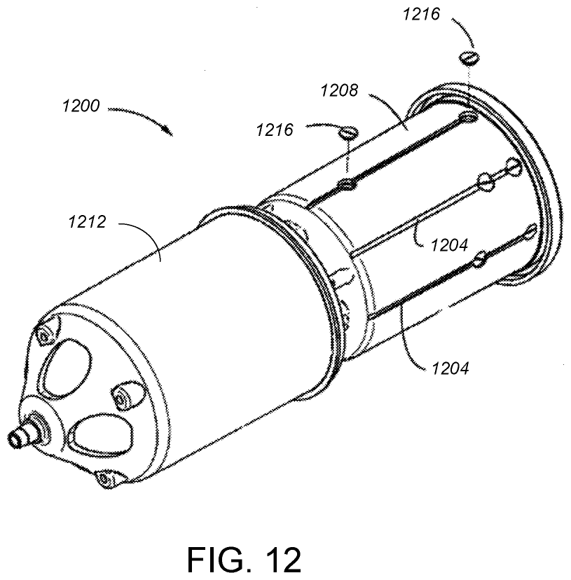

FIG. 12 illustrates an apparatus 1200 having a plurality of channels 1204 disposed on the inner cylinder 1208 within an outer cylinder 1212. Each channel 1204 serves to direct fluid to one or more nozzles 1216. By delivering fluid directly to the nozzles 1216 the speed at which fluid is delivered to the hand and/or forearm of the user may be increased and the time between wash cycles may be decreased. Furthermore, the volume of fluids used per wash cycle is reduced. However, the apparatus 800 differs from the apparatus 1200 which has a transition portion having two defined corners, making the transition portion of the apparatus 1200 more similar to the apparatus 108, such that the improved transition portion 1116 between the frusto-conical portion 1108 and the barrel portion 1112 of apparatus 800 better distributes pressure from the water inlet to the nozzles (e.g., as illustrated in FIG. 111B) as compared to the apparatus 108 and/or the apparatus 1200 (e.g., as illustrated in FIG. 11A).

In addition, the apparatus 800 differs from the apparatus 1200 in that the grooves 1204 of the apparatus 1200 extend from the barrel portion and through the transition region to the frusto-conical portion. In contrast, as illustrated in FIG. 8D and FIG. 111B, the transition region 1116 defining an arc having a radius of curvature allows the grooves 840 to be isolated to the barrel portion 1112, which reduces the possibility of further bottlenecking within the grooves 1204 that may occur in the apparatus 1200.

In this regard, with the improvements to flow through the apparatus 800 and the improvements to the design of the nozzles 900 and 1000, the apparatus 800 is capable of higher cleaning pressure while requiring fewer nozzles, using less water and having less down time, as compared to the apparatus 108 with the nozzles 300, 304, 308, 312 and/or the apparatus 1200 including the nozzles 1216.

More specifically, improvements of the apparatus 800 over the apparatus 108 include, but are not limited to, a decreased flow rate, and a reduced possibility of expansion of the apparatus 800 (e.g., due to pressure) leading to a reduced chance of cylinder 804, 808 or apparatus 800 rupture. The downtime and wastewater are reduced with the use of grooves 840 instead of the annular cavity 324. The velocity and impact force of water and/or cleaning fluid on the object in the cavity 828 is increased.

In addition, the apparatus 800 has a smoother flow through the water inlet, a lower total flow rate, and a more composed spray pattern within the cavity 828 of the inner cylinder 808, with a reduced possibility of splashout at the opening of the apparatus 800 for insertion and removal of the object. It is noted that this may provide a more constant and consistent cleaning between systems 100 within the same facility and/or between facilities, due to the improved pressures within the apparatuses 800 as compared to the apparatuses 108.

Further, the assembly time (e.g., labor time) is reduced with the inclusion of fewer nozzles and/or other components that together comprise the apparatus 800 (as compared to the components of the apparatus 108), while increasing the ease of installation of the apparatus 800 within the system 100. With the overmolding of the nozzles in the apparatus 800, the nozzles may be removable and replaceable as compared to the apparatus 108.

In embodiments, the system 100 includes or is in communication with a control system. The control system may include processors and memory (e.g., a memory medium, memory device, non-transitory computer readable medium, or the like) operable to provide instructions to the components of the system 100. The one or more processors may be configured to execute program instructions maintained on or stored in the memory. The one or more processors of the control system may execute any of the various method or process steps necessary to operate the system 100, and/or the subassemblies and/or components of the system 100. In this regard, at least a portion of the disclosure may be understood as being directed to a computer-implemented method, as at least a portion of the disclosure may be understood as being directed to a computer-implemented disclosure.

In embodiments, the control system may be coupled (e.g., physically coupled, electrically coupled, communicatively coupled, or the like) to a user interface. For example, the user interface may be a separate device coupled to the control system. By way of another example, the user interface and the control system may be located within a common or shared housing.

In embodiments, the user interface may include one or more displays and/or one or more user input devices. Where communication is wired, the user interface may include one or more port connectors (e.g., for the transmitting and/or receiving of power and/or data, and the like).

Generally, any component of the system 100 may include one or more sensors coupled (e.g., physically coupled, electrically coupled, communicatively coupled, or the like) to the control system. The one or more sensors may be operable to determine various operational, physical, and/or environmental parameters of the system 100, the subassemblies and/or components of the system 100, and/or the control system; the environment surrounding the system 100, the subassemblies and/or components of the system 100, and/or the control system; and the like. For example, the sensors may determine when an object is inserted or removed from the cavity 828 (e.g., to start or stop fluid flow), may determine flow rate and/or amount of fluid flow through the apparatus 800 (and/or the system 100 as a whole), and the like.

In embodiments, the control system may include data transmission units (e.g., transmission (Tx), reception (Rx), and/or Tx/Rx units) that operate on satellite, cellular, Bluetooth, Wi-Fi, and other wireless protocols. The one or more transmitters and/or receivers may be coupled (e.g., physically coupled, electrically coupled, communicatively coupled, or the like) to or integrated in the control system, the system 100, and/or the subassemblies and/or components of the system 100. The one or more transmitters and/or receivers may be configured to transmit data and/or receive data for the system 100 and/or the subassemblies and/or components of the system 100 (e.g., from sensors installed within the system 100 and/or the subassemblies and/or components of the system 100) or from external third-party control systems (e.g., controllers, servers, or the like) either via wired connections or wireless connections, which may be configured as transmitting (Tx) units, receiving (Rx) units, or combination Tx/Rx units.

The control system may be configured to monitor the system 100 and/or the subassemblies and/or components of the system 100 via received and/or transmitted data. The control system may be configured to generate control signals to adjust one or more components of the system 100 and/or the subassemblies and/or components of the system 100 via a feedback loop or a feed forward loop based on the received and/or transmitted data, either automatically (or substantially automatically) or following an input from a user. The control system may be configured to receive and/or transmit data in a standardized format and/or a non-standardized format. Where the data is in a non-standardized format, the data may be converted to a standardized format upon receipt and/or prior to transmission to sensors, third-party control systems, or the like.

In some configurations, automation and artificial intelligence may be provided to (or within) the control system. The control system can incorporate predictive analytics (e.g., water usage and/or timing) to enhance automated system maintenance or management, and reduce manual intervention. It is noted that at least a portion of the system 100 may be automated or be “automatic”. The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any computer-readable storage and/or transmission medium that participate in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably and include any type of methodology, process, mathematical operation, or technique.

The term “module” as used herein refers to any known or later developed hardware, software, firmware, artificial intelligence, fuzzy logic, or combination of hardware and software that is capable of performing the functionality associated with that element.

The system may be automated. Examples of the processors used in the automated system may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

The exemplary systems and methods of this disclosure have been described in relation to appendage wash systems. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others. For example, in one alternative embodiment, the apparatus including inner and outer cylinders, and nozzle designs of the present disclosure, may be used to clean any appendage of a user, including arm, leg, wrist, hand, fingernails, and the like. In another alternative embodiment, other nozzle designs are used along with the fluid channels of the inner cylinder.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the disclosure(s) described herein is capable of other embodiments and of being practiced or of being carried out in various ways. It is to be understood that the phraseology and terminology used herein is for the purpose of description and should not be regarded as limiting.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An apparatus for a cleaning station, comprising:
an outer cylinder including a water inlet and at least one opening; and
an inner cylinder including a plurality of apertures and at least one drain in fluid communication with a defined internal cavity, wherein the at least one drain exits through the at least one opening of the outer cylinder; and
a plurality of nozzles, each nozzle of the plurality of nozzles located within a particular aperture of the plurality of apertures, each nozzle of the plurality of nozzles comprising:
an entry aperture within an entry end of the nozzle;
an exit aperture within an exit end of the nozzle; and
a basin in fluid communication with the entry aperture and the exit aperture, wherein a first portion of the basin at the exit aperture is an approximately an ellipsoid with an elliptical cross-section.

2. The apparatus of claim 1, wherein a second portion of the basin at the entry aperture is approximately a frustum with a frusto-conical cross-section, and wherein the frustum transitions into the ellipsoid between the entry aperture and the exit aperture.

3. The apparatus of claim 1, wherein the exit aperture is formed via a wedge cut within the exit end that intersects with the ellipsoid.

4. The apparatus of claim 1, wherein each nozzle of the plurality of nozzles is set in at least one of a particular orientation or a particular angle within the corresponding aperture based on a pre-determined spray pattern within the internal cavity defined within the inner cylinder.

5. The apparatus of claim 1, further comprising:
a second plurality of nozzles, each nozzle of the second plurality of nozzles set within a particular aperture of a second plurality of apertures, each nozzle of the second plurality of nozzles comprising:
a body, comprising:
at least one entry aperture within an entry end of the nozzle;
an exit aperture within an exit end of the nozzle; and
a basin in fluid communication with the at least one entry aperture and the exit aperture; and
a cover with a plug that is insertable into the body, wherein the cover includes a surface that is substantially flush with a surface of the entry end of the nozzle.

6. An apparatus for a cleaning station, comprising:
an outer cylinder including a water inlet and at least one opening; and
an inner cylinder including a plurality of apertures and at least one drain in fluid communication with a defined internal cavity, wherein the at least one drain exits through the at least one opening of the outer cylinder; and
a plurality of nozzles, each nozzle of the plurality of nozzles located within a particular aperture of the plurality of apertures, each nozzle of the plurality of nozzles comprising:
a body, comprising:
at least one entry aperture within an entry end of the nozzle;
an exit aperture within an exit end of the nozzle; and
a basin in fluid communication with the at least one entry aperture and the exit aperture; and
a cover with a plug that is insertable into the body, wherein the cover includes a surface that is substantially flush with a surface of the entry end of the nozzle.

7. The apparatus of claim 6, wherein a portion of the at least one entry aperture is formed by the cover and by the body.

8. The apparatus of claim 6, wherein the basin includes a slot with two wings that meet at a central region proximate to the exit aperture.

9. The apparatus of claim 8, wherein each wing increases in width as a distance from the exit aperture increases.

10. The apparatus of claim 8, wherein the at least one entry aperture comprises two entry apertures, with each entry aperture of the two entry apertures corresponding to a particular wing of the two wings.

11. The apparatus of claim 6, wherein the plug of the cover includes a sloped surface that is insertable into the body, wherein the sloped surface forms jet pathways within the basin between the at least one entry aperture to the exit aperture.

12. The apparatus of claim 11, wherein the jet pathways generate an oscillating spray pattern within the internal cavity defined within the inner cylinder for fluid flowing through the basin between the at least one entry aperture and the exit aperture.

13. The apparatus of claim 6, further comprising:
a second plurality of nozzles, each nozzle of the second plurality of nozzles set within a particular aperture of a second plurality of apertures, each nozzle of the second plurality of nozzles comprising:
an entry aperture within an entry end of the nozzle;
an exit aperture within an exit end of the nozzle; and
a basin in fluid communication with the entry aperture and the exit aperture, wherein a first portion of the basin at the exit aperture is an approximately ellipsoid volume with an elliptical cross-section.

14. An automated cleaning system, comprising:
a pair of apparatuses, each apparatus of the pair of apparatuses comprising:
an outer cylinder including a water inlet; and
an inner cylinder including a plurality of apertures and at least one drain in fluid communication with a defined internal cavity;
a first plurality of nozzles, each nozzle of the first plurality of nozzles located within a particular aperture of the plurality of apertures, each nozzle of the first plurality of nozzles comprising a fan spray nozzle set in at least one of a particular orientation or a particular angle within the corresponding aperture based on a pre-determined spray pattern within the internal cavity defined within the inner cylinder; and
a second plurality of nozzles, each nozzle of the second plurality of nozzles comprising an oscillating spray nozzle, wherein jet pathways within the oscillating spray nozzle generate an oscillating spray pattern within the internal cavity defined within the inner cylinder.

15. The automated cleaning system of claim 14, wherein the fan spray nozzle comprises:
an entry aperture within an entry end of the fan spray nozzle;
an exit aperture within an exit end of the fan spray nozzle; and
a basin in fluid communication with the entry aperture and the exit aperture, wherein a first portion of the basin at the exit aperture is approximately an ellipsoid with an elliptical cross-section.

16. The automated cleaning system of claim 15, wherein a second portion of the basin at the entry aperture is approximately a frustum with a frusto-conical cross-section, and wherein the frustum transitions into the ellipsoid between the entry aperture and the exit aperture.

17. The automated cleaning system of claim 14, wherein the oscillating spray nozzle comprises:
a body, comprising:
at least one entry aperture within an entry end of the oscillating spray nozzle;
an exit aperture within an exit end of the oscillating spray nozzle; and
a basin in fluid communication with the at least one entry aperture and the exit aperture; and
a cover with a plug that is insertable into the body, wherein the cover includes a surface that is substantially flush with a surface of the entry end of the oscillating spray nozzle.

18. The automated cleaning system of claim 17, wherein the plug of the cover includes a sloped surface that is insertable into the body, wherein the sloped surface forms the jet pathways within the basin between the at least one entry aperture to the exit aperture.

19. The automated cleaning system of claim 14, wherein an inner surface of the outer cylinder substantially abuts an outer surface of the inner cylinder such that flow from the water inlet to the plurality of apertures is routed through grooves in the outer surface of the inner cylinder.

20. The automated cleaning system of claim 19, wherein each apparatus of the pair of apparatuses includes a conical portion and a barrel portion with a transition portion therebetween, wherein the grooves are substantially located in the barrel portion of the apparatus, and wherein a radius of curvature of the transition portion is pre-determined to reduce flow pressure within the water inlet and increase a flow rate through the grooves to the plurality of apertures.
